(19) United States
(12) Patent Application Publication
(10) Pub. No.: US 2014/0162016 A1
(43) Pub. Date: Jun. 12, 2014

(54) MOLDED ARTICLE PRODUCING METHOD AND MOLDED ARTICLE

(71) Applicant: Sony Corporation, Tokyo (JP)

(72) Inventors: Takeshi Matsui, Tokyo (JP); Nobuhiro Kihara, Kanagawa (JP); Junichi Kazusako, Saitam (JP)

(73) Assignee: Sony Corporation, Tokyo (JP)

(21) Appl. No.: 14/086,769

(22) Filed: Nov. 21, 2013

(30) Foreign Application Priority Data
Dec. 6, 2012 (JP) 2012-267034

(51) Int. Cl. B29C 70/68; B29C 67/00

(52) U.S. Cl. CPC B29C 70/682; B29C 67/0092
USPC 428/76; 264/279; 264/401; 264/78

(57) ABSTRACT

A method of producing a molded article includes forming an outer portion of a material that is soluble in a solvent, the outer portion having a predetermined shape; forming a covering portion of a first flexible material, the covering portion covering the outer portion, the first flexible material being insoluble in the solvent; dissolving the outer portion with the solvent, the outer portion being covered by the covering portion; and filling an area covered by the covering portion with a second flexible material, the area being obtained by dissolving the outer portion.

### CROSS REFERENCE TO RELATED APPLICATIONS

This application claims the benefit of Japanese Priority Patent Application JP 2012-267034 filed Dec. 6, 2012, the entire contents of which are incorporated herein by reference.

### BACKGROUND

The present disclosure relates to a method of producing a molded article, which is capable of using an additive manufacturing technology, and to the molded article.

Japanese Patent Application Laid-open No. Sho 63-236627 discloses a technology in which a model of a human body is produced by an additive manufacturing technology. Specifically, in the producing method, information on a cross-section of multiple layers is obtained by performing, by a computer, graphics processing on shape data obtained by using a CT (Computed Tomography) scanner, and a model of a human body is formed by applying a light beam to photosensitive resin to cure the photosensitive resin for each unit of thickness based on the information on a cross-section of multiple layers (see, for example, Japanese Patent Application Laid-open No. Sho 63-236627).

Moreover, as an example using an additive manufacturing technology, the three-dimensional molding apparatus disclosed in Japanese Patent Application Laid-open No. 2010-194942 uses an inkjet head to selectively supply a powder material with ink based on CT image data, and thus cures the powder material to form a molded article (see, for example, Japanese Patent Application Laid-open No. 2010-194942).

### SUMMARY

There is a need for a technology capable of producing a molded article having high reproducibility with respect to not only the appearance but also the internal structure thereof.

In view of the circumstances as described above, it is desirable to provide a method of producing a molded article having high reproducibility with respect to not only the appearance but also the internal structure thereof, and the molded article.

According to an embodiment of the present disclosure, there is provided a method of producing a molded article, including forming an outer portion of a material that is soluble in a solvent, the outer portion having a predetermined shape. A covering portion is formed of a first flexible material, the covering portion covering the outer portion, the first flexible material being insoluble in the solvent. The outer portion is dissolved with the solvent, the outer portion being covered by the covering portion. An area covered by the covering portion is filled with a second flexible material, the area being obtained by dissolving the outer portion.

In the method of producing a molded article, the outer portion having the predetermined shape is formed, and the covering portion covering the outer portion is formed of the first flexible material. The outer portion is dissolved in the solvent, and the area covered by the covering portion thus obtained is filled with the second flexible material. As a result, it is possible to produce a molded article having high reproducibility with respect to not only the appearance but also the internal structure thereof.

The outer portion may be formed by an additive manufacturing technology.

As described above, the outer portion may be formed by an additive manufacturing technology. Accordingly, it is possible to produce a molded article having high reproducibility.

The solvent may include water as a main component. In this case, the material that is soluble in the solvent may include salt as a main component.

By using the solvent and the material, which include water and salt, respectively, as a main component, it is possible to easily perform the forming of the outer portion and the dissolving.

The first flexible material may include a material through which visible light is transmitted.

Accordingly, it is possible to produce a molded article including a transparent covering portion, for example. For example, because it is possible to observe the inside of the molded article from the outside of the covering portion, it is possible to produce a molded article that is useful for surgery simulation or the like.

The first flexible material and the second flexible material may include one of a natural polymer and a synthetic polymer as a main component.

The first flexible material to be used for the covering portion and the second flexible material to be filled in the molded article may include the same material or different materials. As described above, a natural polymer or a synthetic polymer may be used as the first and second flexible materials. The type of the flexible material may be appropriately selected depending on the type of the target object to be molded or the like.

The first flexible material may include the synthetic polymer as a main component. In this case, the second flexible material may include the natural polymer as a main component.

As described above, the first flexible material and the second flexible material may be separately selected. The type of the flexible material may be appropriately selected depending on the type of the target object or the like.

The synthetic polymer may include one of silicone rubber and urethane resin. In this case, the natural polymer may include one of gelatin and konjac.

The outer portion may be formed so as to have internal space. In this case, the method of producing a molded article may further include forming a molded body of a molding material that is insoluble in the solvent, and disposing the formed molded body in the internal space, prior to the forming of the covering portion. Moreover, the forming of the covering portion and the dissolving may be performed in a state where the molded body is disposed in the internal space. Moreover, the filling may be performed in a state where the molded body is disposed in the area covered by the covering portion.

Accordingly, it is possible to produce a molded article having high reproducibility, which includes a molded body.

The outer portion may be formed so as to resemble an organ. In this case, the molded body may be formed so as to resemble a biological tissue included in the organ.

With the producing method, it is possible to produce a molded article having high reproducibility with respect to an organ including a biological tissue.

The biological tissue may include one of a blood vessel and a tumor.

Accordingly, for example, it is possible to produce a molded article that is useful for surgery simulation for removing a tumor.

The molding body may be formed so as to resemble the blood vessel and to be hollow.

Accordingly, it is possible to form a molded body so as to resemble a blood vessel having high reproducibility. For example, it is possible to reproduce a state where blood, a contrast medium, or the like flows through the blood vessel.

The method of producing a molded article may further include forming a resection area portion in a case where the molded body is formed so as to resemble the tumor, the resection area portion being an area for resecting the molded body.

Accordingly, it is possible to produce a molded article that is useful for surgery simulation for removing a tumor or the like.

The forming of the resection area portion may be performed by forming the molded body and the resection area portion during the forming of the molded body, the resection area portion including the molded body.

As described above, the resection area portion may be formed during the forming of the tumor being the molded body. Accordingly, it is possible to reduce the number of processes.

The forming of the resection area portion may be performed by, during the filling of the second flexible material, preparing a plurality of types of flexible materials as the second flexible material, filling around the molded body with a flexible material for the resection area portion, and filling other areas with a type of flexible material different from the flexible material for the resection area portion.

As described above, a plurality of types of flexible materials may be prepared as the second flexible material. Then, a flexible material for the resection area portion may be used to form the resection area portion.

In the forming of the resection area portion, the resection area portion may be formed so as to include a material stained with a predetermined staining material. In this case, in the forming of the molded body, the molded body formed so as to resemble the blood vessel through which the predetermined staining material is allowed to flow and to be hollow may be formed so as to connect to the formed resection area portion.

Accordingly, it is possible to simulate the action of injecting a contrast medium or the like from a blood vessel to stain a tumor portion, for example.

The forming of the resection area portion may be performed by forming the covering portion in a state where the molded body is covered with the material for the resection area portion during the disposing of the molded body, dissolving the outer portion, and filling the second flexible material.

As described above, a material for the resection area portion may be used to form the resection area portion. By providing a material for the resection area portion so as to cover a tumor, it is possible to easily form the resection area portion.

The material for the resection area portion may be a material stained by a predetermined staining material. In this case, in the forming of the molded body, the molded body formed so as to resemble the blood vessel through which the predetermined staining material is allowed to flow and to be hollow may be formed so as to connect to the resection area portion formed based on the material for the resection area portion.

Accordingly, it is possible to simulate the action of injecting a contrast medium or the like from a blood vessel to stain a tumor portion, for example.

The resection area portion may be formed for surgery simulation for removing a tumor.

In the producing method, it is possible to produce a molded article that is useful for surgery simulation for removing a tumor.

A molded article according to an embodiment of the present disclosure includes a first molded portion and a second molded portion.

The first molded portion includes a first flexible material that is insoluble in a solvent, the first molded portion being formed as a covering portion having a predetermined shape by being formed so as to cover an outer portion including a material that is soluble in the solvent and having the predetermined shape.

The second molded portion includes a second flexible material, the second molded portion being formed as an internal area covered by the covering portion by filling an area covered by the first molded portion with the second flexible material, the area being obtained by dissolving the outer portion with the solvent, the outer portion being covered by the first molded portion.

The molded article is formed so that the first molded portion formed as the covering portion covers the outer portion having a predetermined shape. Moreover, the second molded portion formed as an area covered by the covering portion is formed by filling an area covered by the first molded portion, which is obtained by dissolving the outer portion, with the second flexible material. Accordingly, it is possible to obtain high reproducibility with respect to the appearance and the internal structure.

As described above, according to the present disclosure, it is possible to produce a molded article having high reproducibility with respect to the appearance and the internal structure.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a molding apparatus according to an embodiment of the present disclosure;

FIG. 2 is a side view of the molding apparatus shown in FIG. 1;

FIG. 3 is a plan view of the molding apparatus shown in FIG. 1;

FIG. 4 is a perspective view viewed from below, showing a print head according to this embodiment;

FIGS. 5A-5D are each a schematic diagram viewed from the side, sequentially showing mechanical operations carried out by the molding apparatus;

FIGS. 6A-6E are each a schematic diagram for explaining the overview of a method of producing a molded article according to this embodiment;

FIG. 7 is a flowchart showing a detailed process of the method of producing a molded article according to this embodiment;

FIG. 8 is a flowchart showing a detailed process of the method of producing a molded article according to this embodiment;

FIGS. 9A-9B are each a diagram for explaining a target object to be molded according to this embodiment;

FIGS. 10A-10B are each a diagram showing a molded portion extracted in this embodiment;

FIGS. 11A-11B are each a diagram for explaining the forming of an outer portion according to this embodiment;

FIGS. 12A-12B are each a diagram for explaining the forming of the outer portion according to this embodiment;

FIG. 13 is a photograph showing models of a blood vessel and a tumor serving as a molded body according to this embodiment;

FIG. 14 is a diagram for explaining a blood vessel portion formed so as to resemble a blood vessel and to be hollow;

FIGS. 15A-15B are each a diagram for explaining the blood vessel portion formed so as to resemble a blood vessel and to be hollow;

FIG. 16 is a photograph showing a process of applying wax to a right divided portion and a left divided portion formed as the outer portion;

FIGS. 17A-17B are each a photograph for explaining the assembly of the outer portion according to this embodiment;

FIG. 18 is a photograph for explaining the assembly of the outer portion according to this embodiment;

FIG. 19 is a photograph showing a process of forming a covering portion according to this embodiment;

FIGS. 20A-20B are each a photograph showing a process of dissolving the outer portion according to this embodiment;

FIGS. 21A-21B are each a photograph showing a process of filling a second flexible material according to this embodiment;

FIGS. 22A-22B are each a photograph showing a process of extracting a liver model from lumps of gelatin;

FIGS. 23A-23B are each a photograph showing the completed liver model;

FIG. 24 is a table showing examples of the outer portion, a molded body disposed in the outer portion, a filling reinforcement material applied to the outer portion, a first flexible material to be the covering portion, and a second flexible material to be filled in the inside;

FIGS. 25A-25B are each a diagram for explaining the resection area portion for resecting a tumor;

FIGS. 26A-26B are each a diagram showing an example of a method of forming the resection area portion according an embodiment of the present disclosure;

FIG. 27 is a diagram showing another example of the method of forming the resection area portion;

FIG. 28 is a diagram showing another example of the method of forming the resection area portion;

FIGS. 29A-29B is a diagram showing an example of a molded body according to various fields, which can be produced in the present disclosure; and

FIGS. 30A-30B are each a diagram showing an example of a molded body according to various fields, which can be produced in the present disclosure;

### DETAILED DESCRIPTION OF EMBODIMENTS

Hereinafter, an embodiment of the present disclosure will be described with reference to the drawings.

### <Molding Apparatus>

### [Configuration of Molding Apparatus]

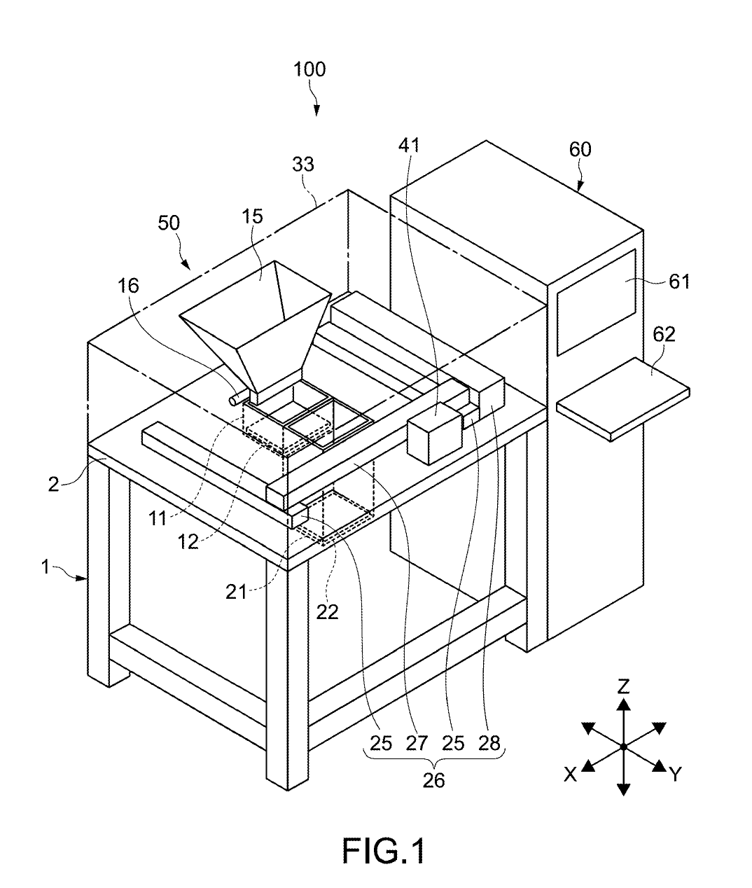

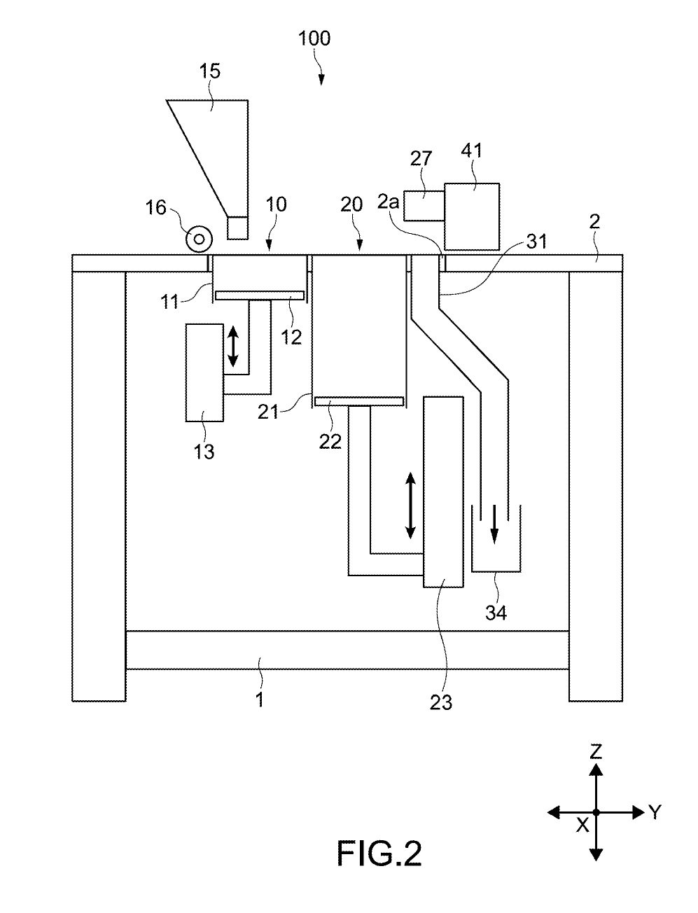

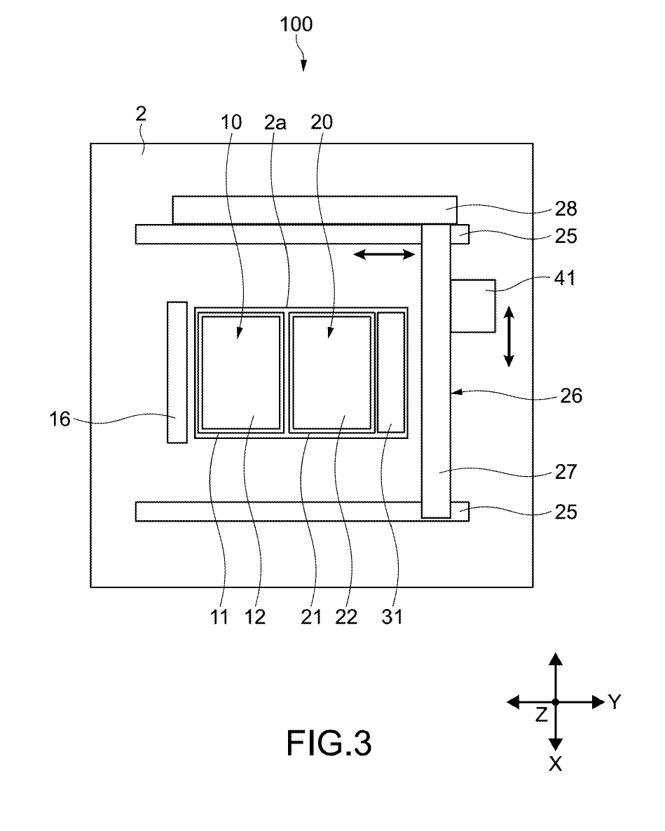

FIG. 1 is a diagram showing a molding apparatus according to an embodiment of the present disclosure. FIG. 2 is a side view of the molding apparatus shown in FIG. 1, and FIG. 3 is a plan view thereof.

A molding apparatus 100 includes a molding unit 50 and a control unit 60 disposed adjacent to the molding unit 50. The molding unit 50 includes a frame 1 and a plate 2 fixed on the frame 1. At an almost central part of the plate 2, an opening 2a for molding operation is provided. Below the opening 2a, a supply unit 10 of a powder material (hereinafter, referred to as simply powder), a molding unit 20 that forms a molded article with the powder, and a discharging path member 31 of the powder (which is omitted in FIG. 1) are disposed. As shown in FIG. 2 and FIG. 3, the supply unit 10, the molding unit 20, and the discharging path member 31 are sequentially disposed from the left side of the figures along a Y-direction.

It should be noted that a frame (not shown) is provided on the plate 2, and a cover is attached to the frame as shown in FIG. 1. The cover is formed of acrylic or the like, and a user can see the inside of the molding unit 50 from the outside thereof. Moreover, an anti-static process is applied to the cover so that a visibility is not reduced due to the attachment of a static-charged powder.

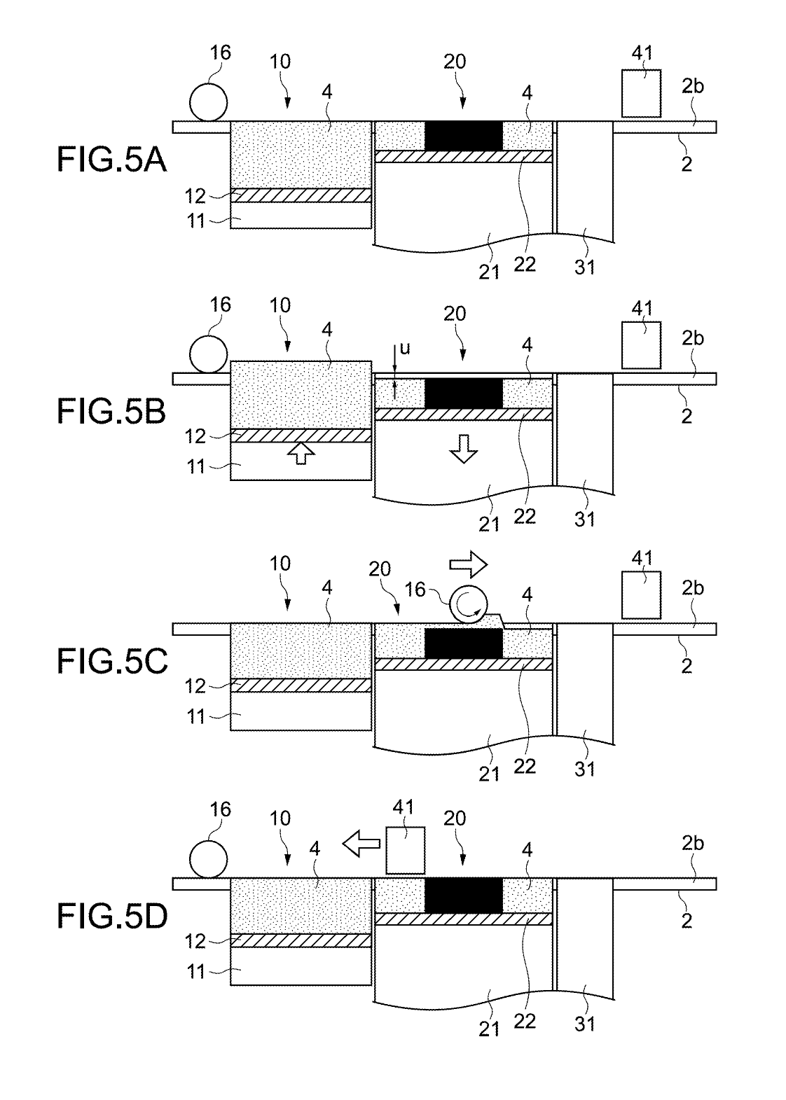

The supply unit 10 includes a supply box 11 capable of reserving a powder 4 (see FIGS. 5A-5D), a supply stage 12 disposed in the supply box 11, which supplies the powder 4 on the plate 2 via the opening 2a by pushing up the powder 4 reserved in the supply box 11, and an elevating mechanism 13 that elevates the supply stage 12 in the supply box 11. As the elevating mechanism 13, a ball screw mechanism, a belt mechanism, a rack-and-pinion mechanism, a cylindrical mechanism, or the like is used.

As shown in FIG. 1 and FIG. 2, on the supply unit 10, a tank shooter 15 to which the powder is supplied by an operator or a robot and in which the powder is temporarily stored is provided. At the bottom of the tank shooter 15, a cover (not shown) that opens and closes by electrical control, for example, is provided. If the cover is opened, the stored powder drops by its own weight and is supplied to the supply unit 10.

As the powder 4, a material that is soluble in a solvent is used. In this embodiment, as the solvent, a solvent including water as a main component is used. Therefore, as the powder 4, a water-soluble material including salt as a main component is used.

In addition, as the water-soluble material, inorganic materials such as magnesium sulphate, magnesium chloride, potassium chloride, and sodium chloride may be used. A mixture of sodium chloride and a bittern component (magnesium sulphate, magnesium chloride, potassium chloride, or the like) may be used. The mixture includes sodium chloride as a main component. Alternatively, organic materials such as polyvinyl pyrrolidone, polyvinyl alcohol, carboxymethyl cellulose, ammonium polyacrylate, sodium polyacrylate, ammonium methacrylate, sodium methacrylate, and a copolymer thereof can also be used.

The average particle diameter of the powder 4 is typically not less than 10 μm and not more than 100 μm. In the case where salt is used, it is environmentally-friendly because the extraction or processing of the powder material needs only low energy as compared with the case where a powder material such as metal and plastic is used,

The molding unit 20 disposed adjacent to the supply unit 10 is disposed in a molding box 21 capable of reserving the powder 4, and includes molding stage 22 on which the powder 4 is stuck, which supports a molded article to be formed from below, and an elevating mechanism 23 that elevates the molding stage 22 in the molding box 21. As the elevating mechanism 23, a ball screw mechanism, a belt mechanism, a rack-and-pinion mechanism, a cylindrical mechanism, or the like is used.

In FIG. 2, the length of the molding box 21 in an X-direction is set to 20 to 50 cm, and the length of the molding box 21 in the Y-direction is set to 10 to 30 cm, which are not limited to the range. An area in which the powder housed in the molding box 21 is disposed is a molding enabling area.

The upper portions of the boxes 11 and 21 and the member 31 are opened, and the opening surfaces thereof are disposed so as to face the opening 2a of the plate 2.

In the vicinity of the end portion of the opening 2a of the plate 2 on the side of the supply unit 10, a roller 16 that conveys, to the molding unit 20, the powder 4 supplied from the supply unit 10 is disposed. The roller 16 includes a rotational axis 17 provided along a direction orthogonal to arrangement directions of the boxes 11 and 21 and the member 31 in a horizontal plane, i.e., X direction. A motor (not shown) that rotates the rotational axis 17 is also provided. On the plate 2, a mechanism (not shown) that moves the roller 16 in the Y direction is provided.

As shown in FIG. 2, the discharging path member 31 is provided so as to be bent to avoid the elevating mechanism 23. Below the discharging path member 31, a collecting box 34 is disposed. The excess powder dropping through the discharging path member 31 by its own weight is collected in the collecting box 34.

On the plate, a print head 41 and a movement mechanism 26 that moves the print head 41 in the X-Y directions are provided. The print head 41 is capable of discharging ink to the powder 4 on the molding stage 22 in the molding unit 20.

The movement mechanism 26 includes guiderails 25 extended along the Y-direction at both sides of the opening 2a in the X-direction, a Y-axis driving mechanism 28 provided at the end portion of the guiderails 25, and an X-axis driving mechanism 27 bridged between the guiderails 25. The print head 41 is connected to the X-axis driving mechanism 27 so that the print head 41 is capable of moving in the X-direction. Moreover, the X-axis driving mechanism 27 is capable of moving in the Y-direction along the guiderail 25 by the Y-axis driving mechanism 28. The X-axis driving mechanism 27 and the Y-axis driving mechanism 28 include a ball screw mechanism, a belt mechanism, a rack-and-pinion mechanism, or the like.

The control unit 60 has a function of a computer including a CPU (central processing unit), a RAM (random access memory), and a ROM (read only memory). Moreover, the control unit 60 includes a display unit 61 disposed on the upper portion of the front surface, and an input operation device 62 disposed on the lower portion thereof. The input operation device 62 typically includes a keyboard. The display unit 61 may include an input device using a touch panel.

To the control unit 60, CT (Computed Tomography) data is input. The control unit 60 controls the movement of the respective units of the molding unit 50 and timing of the movement based on the input CT data to form a molded article. The CT data is at least one of data of a CT histogram and CT image data, for example, as will be described later.

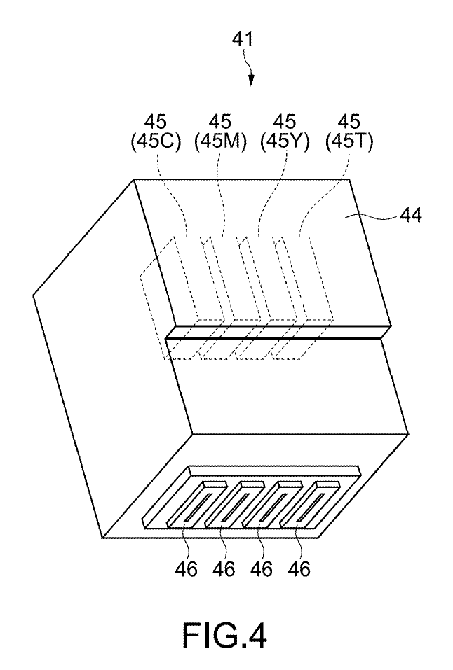

FIG. 4 is a perspective view viewed from below, showing the print head 41 according to an embodiment of the present disclosure.

As the print head 41, one having the structure of the print head 41 for a general printer may be used. For example, in a case 44 of the print head 41, a plurality of ink reservoirs 45 are provided. The plurality of ink reservoirs 45 include reservoirs 45C, 45M, and 45Y, which store ink of colors of cyan, magenta, and yellow (hereinafter, referred to as CMY), respectively.

Moreover, in the case 44, a reservoir 45T that stores transparent ink, for example, is provided. The transparent ink includes a hardener that cures the powder 4. Any hardener can be used as long as the cured powder 4 is soluble in a solvent. For example, a water-soluble adhesive may be used as a hardener. In the case where the powder 4 includes a binder such as polyvinyl alcohol in advance, ink including no hardener may be used. Alternatively, conversely, a binder such as polyvinyl alcohol may be used as a hardener. In this case, the amount of components of the binder is appropriately determined so that the cured powder 4 is soluble in a solvent.

Ink of each color stored in the reservoirs 45C, 45M, and 45Y include no hardener that is included in the transparent ink in the reservoir 45T. As a material of the ink of each color, aqueous ink may be used, for example. Ink for a commercially available inkjet printer may also be used. The ink may be oily depending on the material of the powder 4 or the material of the solvent. On the contrary, ink including a hardener may be used.

Below the print head 41, a plurality of inkjet heads 46 are disposed. The inkjet heads 46 are connected to the ink reservoirs 45 through a flow path of ink (not shown). The inkjet heads 46 are capable of discharging ink using a well-known mechanism such as a piezoelectric inkjet head and a thermal inkjet head. By using the inkjet head 46, it is possible to form a molded article with high precision.

### [Operation of Molding Apparatus]

FIGS. 5A-5D are each a schematic diagram viewed from the side, sequentially showing mechanical operations carried out by the molding apparatus 100. Before the molding apparatus 100 forms a molded article, CT data of a target object to be molded is input to the control unit 60. In the medical field, three-dimensional image data being CT image data is treated as DICOM (Digital Imaging and COmmunication in Medicine) data, for example. The molding unit 50 is formed by laminating a molded article layer by layer based on the CT data. The DICOM data may include colored image data. In this case, the molding apparatus 100 is capable of forming a colored molded article.

FIGS. 5A to 5D show, as will be described later, a process in which the print head 41 discharges ink and thus a layer obtained by curing the powder 4 (which has a predetermined thickness) is formed. The powder 4 and uncured powder 4 are represented by hatching of dots, and the cured layer is represented by black paint.

As shown in FIG. 5A, the powder 4 is supplied from the tank shooter 15 and is already stored in the supply box 11. On the molding stage 22 of the molding unit 20, a layer of cured and uncured powder is laminated. From the state, the process of forming a cured layer is started. In FIG. 5A, positions representing the roller 16 and the print head 41 are their standby positions.

First, as shown in FIG. 5B, the powder 4 stuck on the supply stage 12 of the supply unit 10 is pushed up by the elevating mechanism 13 (see FIG. 2), and a slightly excess amount of the powder 4 than the amount of a layer of the powder 4 is supplied to the position higher than that of an upper surface 2b of the plate 2. Moreover, in the molding unit 20, the molding stage 22 is elevated by the elevating mechanism 23, and thus space having a thickness of a layer of powder layer (cured layer) is provided between the upper surface 2b of the plate 2 and the upper surface of the layer of cured and uncured powder.

In FIG. 5B, a thickness u of a layer of the powder layer may typically be about 0.1 mm to 0.2 mm, but may be larger or smaller than the range.

As shown in FIG. 5C, the roller 16 moves in a direction of a solid-white arrow while rotating in a counterclockwise direction in FIG. 5C, and thus the powder 4 supplied from the supply unit 10 is conveyed. Here, with the roller 16 being rotated freely (free rotating force being exerted on the rotational shaft of the roller 16) and being moved in a direction indicated by the solid-white arrow, the roller 16 is rotated in a direction opposite to a direction in which the roller 16 may rotate due to the friction between the roller 16 and the molding unit 20. Because the powder 4 is conveyed due to the rotation of the roller 16, the gap in the upper surface of the layer of cured and uncured powder in the molding unit 20 is filled with the powder 4, whereby an even powder layer is formed.

As shown in FIG. 5D, the roller 16 passes over the molding unit 20, and discharges the excess amount of powder 4 from the discharging path member 31. The print head 41 discharges ink so as to draw the colored image while moving by driving of the movement mechanism 26 in synchronization with the operation of the roller 16 to return to the standby position. In this case, aqueous ink (colored ink and transparent ink) permeates through the powder layer, and the powder 4 in the portion where the ink is discharged is adhered with each other. Thus, the cured layer is formed.

Here, in order to cure the powder, the print head 41 discharges transparent ink including a hardener. Specifically, by discharging transparent ink in an area in which the colored ink (CMY ink) is discharged, a cured layer of the colored powder is formed.

It should be noted that in the case where uncolored cured layer is formed, the print head 41 only has to selectively discharge only transparent ink in the molding enabling area.

It should be noted that after the roller 16 conveys the powder 4 and returns to the standby position, the print head 41 may start to move and start to discharge ink. However, as described above, the time slot when the roller 16 returns corresponds to the time slot when the head moves, and thus it is possible to reduce the processing time.

When the print head 41 returns to the standby position, it returns to the state shown in FIG. 5A. In this way, a layer of colored cured product, which corresponds to molding data, is formed. The molding apparatus 100 repeats such operations, and a cured layer is laminated. Thus, a molded article is formed.

After the molded article is taken out by an operator or a robot, it is possible to obtain a molded article with higher hardness by heating the molded article by a heating apparatus (not shown) different from the molding apparatus 100.

### [Method of Producing Molded Article According to Present Disclosure]

In recent years, with the widespread use of a CT scanning apparatus or MRI (Magnetic Resonance Imaging) apparatus, it is becoming more common to obtain an image of affected areas of a specific individual, observe a state of the affected areas on a screen of a PC (Personal Computer), or to perform simulations for performing plastic surgeries. These actions have various merits such as reduction of the burden on a patient during surgery by the reduction of the surgery time, and reduction of the burden on a doctor by such a simulation prior to surgery. Furthermore, a modelized real organ or the like is used to perform the simulation prior to surgery in some cases. Hereinafter, a method of producing a molded article including such affected areas of a patient by using the molding apparatus 100 will be described.

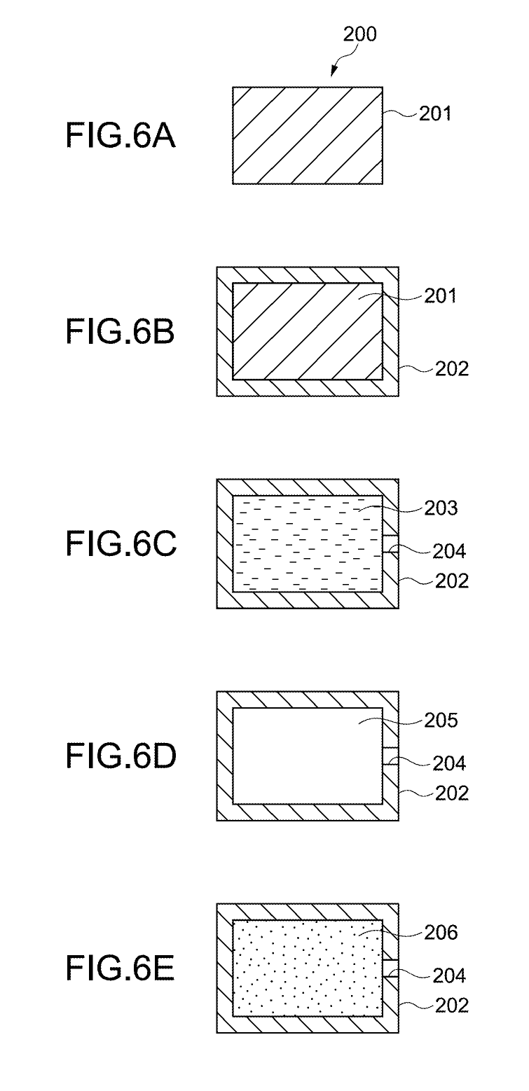

FIGS. 6A-6E are each a schematic diagram for explaining the overview of a method of producing a molded article 200 according to this embodiment. In the producing method, as shown in FIG. 6A, an outer portion 201 having a predetermined shape is formed of a material that is soluble in a solvent. The predetermined shape represents the outer shape of a target object to be molded such as an organ. In this embodiment, the molding apparatus 100 described above is used to form the outer portion 201 of a water-soluble material. Specifically, the outer portion 201 is formed by an additive manufacturing technology.

Next, as shown in FIG. 6B, a covering portion 202 that covers the outer portion 201 is formed of a first flexible material that is insoluble in a solvent. In this embodiment, the outer portion 201 is covered with a flexible coating agent, and thus the covering portion 202 is formed. The shape of the outer portion 201, i.e., the outer shape of the target object to be molded, is transferred to the covering portion 202. Therefore, the outer portion 201 functions as a mold.

As shown in FIGS. 6C and 6D, the outer portion 201 covered by the covering portion 202 is dissolved with a solvent 203. In this embodiment, the solvent 203 including water as a main component is used, and the solvent 203 enters the covering portion 202. Thus, the outer portion 201 is dissolved. Therefore, at the predetermined position of the covering portion 202, an opening 204 is formed. The opening 204 may be formed after the covering portion 202 is formed. Alternatively, a portion where the covering portion 202 is not formed is set at a predetermined position, and the position may be the opening 204. The outer portion 201 dissolved with the solvent 203 is used as a dissolving mold.

As shown in FIGS. 6D and 6E, a second flexible material 206 is filled in an area 205 covered by the covering portion 202, which is obtained by dissolving the outer portion 201. Accordingly, the molded article 200 according to this embodiment is formed. Therefore, the molded article 200 includes the covering portion 202, and the second flexible material 206 to be the internal area covered by the covering portion 202. The covering portion 202 corresponds to a first molding portion, and the second flexible material 206 filled in the internal area corresponds to s second molding portion. As described above, when the covering portion 202 is formed, the outer portion 201 is used as the dissolving mold. On the other hand, when the second flexible material 206 is filled, the covering portion 202 functions as a mold. Then, the filled second flexible material 206 and the covering portion 202 used as a mold are used to form the molding article 200 according to this embodiment.

As the first and second flexible materials, natural polymers such as silicone rubber and urethane resin are used. Alternatively, natural polymers such as gelatin, konjac (glucomannan), and agar are used. However, the first and second flexible materials are not limited thereto, and may be appropriately selected depending on the type of the target object to be molded, or the like. It should be noted that the first flexible material needs to be insoluble in the solvent 203.

The first and second flexible materials may include the same material or different materials. For example, the first flexible material includes a synthetic polymer as a main component, and the second flexible material includes a natural polymer as a main component. For example, a case where the molded body 200 (soft model) is formed for a soft object such as an organ will be considered. In this case, the covering portion 202 that determines the outer shape of the molded article 200 is formed of a material including a synthetic polymer as a main component. Then, a natural polymer is used as the second flexible material to be the internal area. Accordingly, it is possible to form the molded article 200 with high reproducibility. As a result, it is possible to produce the molded article 200 that is useful for surgery simulation or the like.

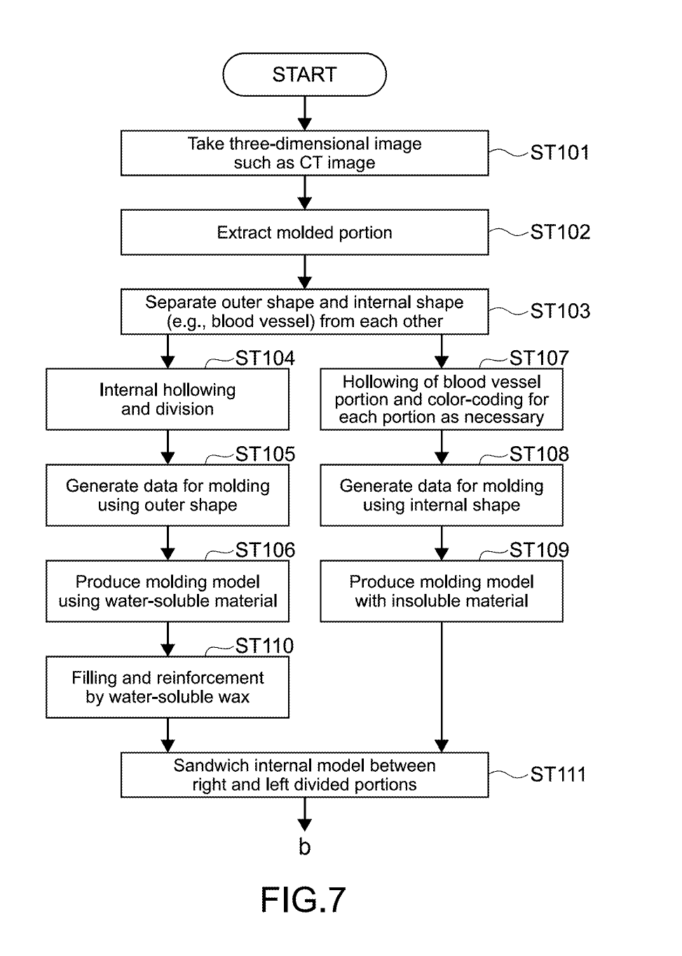

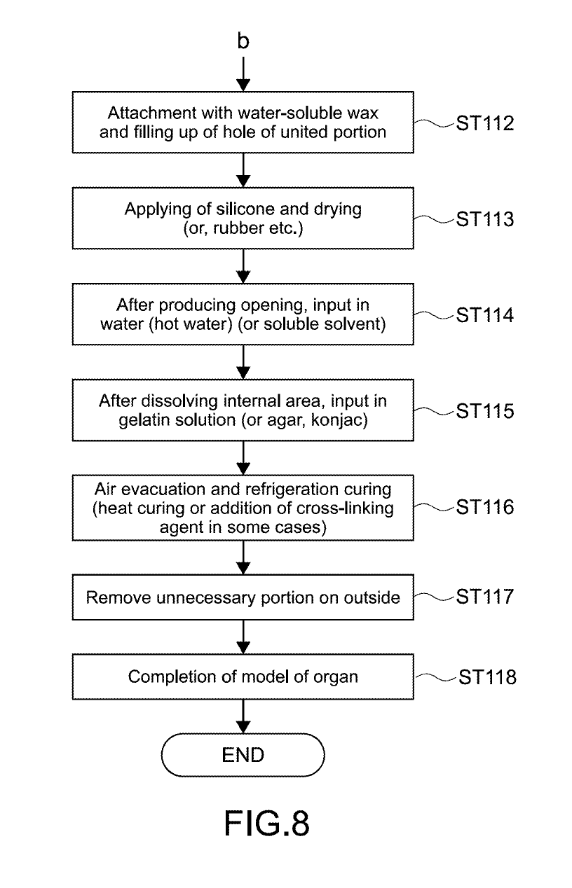

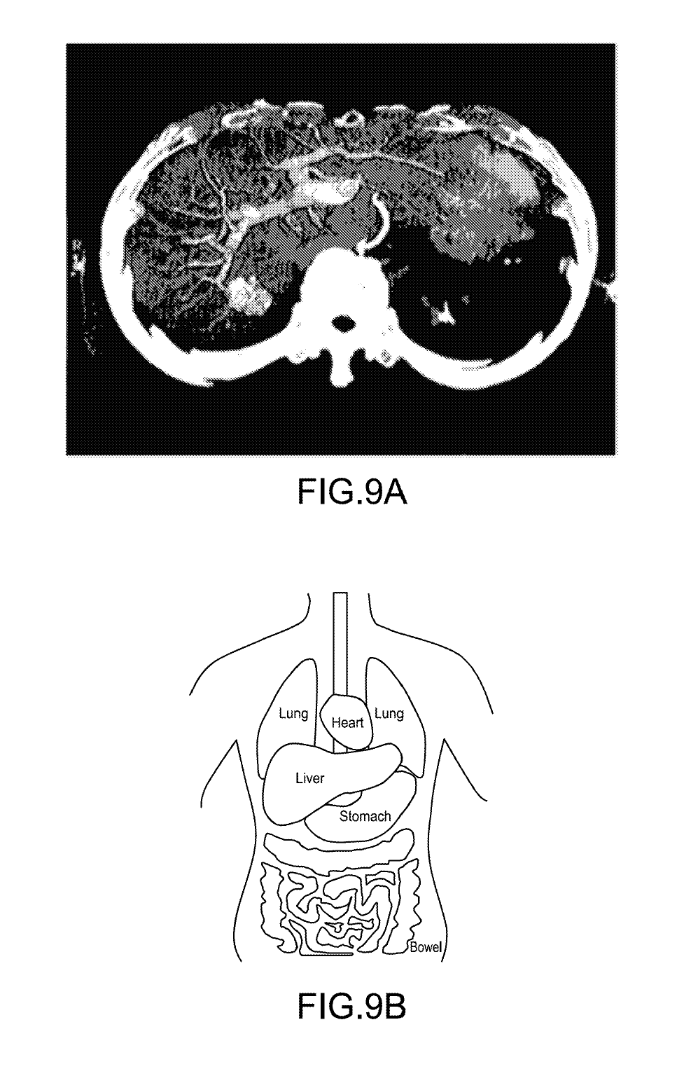

FIG. 7 and FIG. 8 are each a flowchart showing flow of a detailed process of the method of producing a molded article according to this embodiment. FIGS. 9A-9B are each a diagram for explaining a target object to be molded according to this embodiment.

As shown in FIG. 7, a three-dimensional image of a molded article to be molded is taken (step 101). The method of taking a three-dimensional image or the like is not limited. It should be noted that if it is possible to three-dimensionally see the target object, any image may be used as the three-dimensional image. In this embodiment, a CT image that is shown as an example in FIG. 9A is taken. For example, it is possible to three-dimensionally see the state of each organ by using a group of CT images having a fine pitch. In this embodiment, based on the CT image, a liver is used as a target object to form a molded article. In addition, as shown in FIG. 9B, a heart, a lung, a stomach, a bowel, a brain (not shown), or the like may be used as the target object to form the molded article. It is possible to form a model of an organ or the like, which includes the soft object, with high reproducibility.

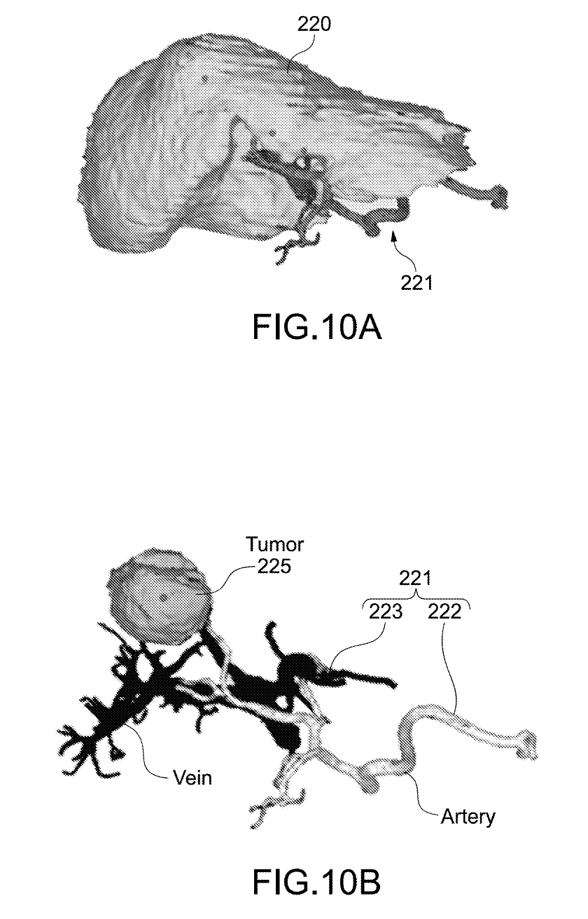

A molded portion is extracted from the CT image (step 102). The molded portion corresponds to the target object to be molded. FIGS. 10A-10B are each a diagram showing the molded portion extracted in this embodiment. As shown in FIG. 10A, a liver 220 is extracted as the molded portion in this embodiment. Moreover, as shown in FIG. 10B, a blood vessel 221 and a tumor 225 such as a cancer are also extracted as a biological tissue included in the liver 220.

The method of extracting the portions of the liver 220, the blood vessel 221, and the tumor 225 from the CT image is not limited, and a well-known technology may be used. For example, the CT image is filtered from CT histogram data based on the CT value. Accordingly, it is possible to extract the outer shape of the liver 220. In addition, any technology for extracting the organ, the blood vessel 221 such as an artery 222 and a vein 223, the tumor 225, or the like from the CT image may be used. It should be noted that the portion extracted as the biological tissue is not limited to the blood vessel 221 or the tumor 225.

In step 103 in FIG. 7, the outer portion of the liver 220, the internal blood vessel 221, and the like are separated from each other. Accordingly, an image representing the shape (referred to as outer shape) of the liver 220 excluding the blood vessel 221 shown in FIG. 10A is generated. Moreover, an image representing the shape (referred to as internal shape) of the blood vessel 221 and the tumor 225 shown in FIG. 10B is generated.

It should be noted that as shown in FIG. 10B, an image may be generated with distinguishing the colors of the portions of the artery 222, the vein 223, and the tumor 225. For example, based on the color coding, the molded article to be formed is color-coded. Accordingly, it is possible to produce a molded article that is useful for surgery simulation, observation, or the like. Any technology may be used as the method of producing a color-coded image.

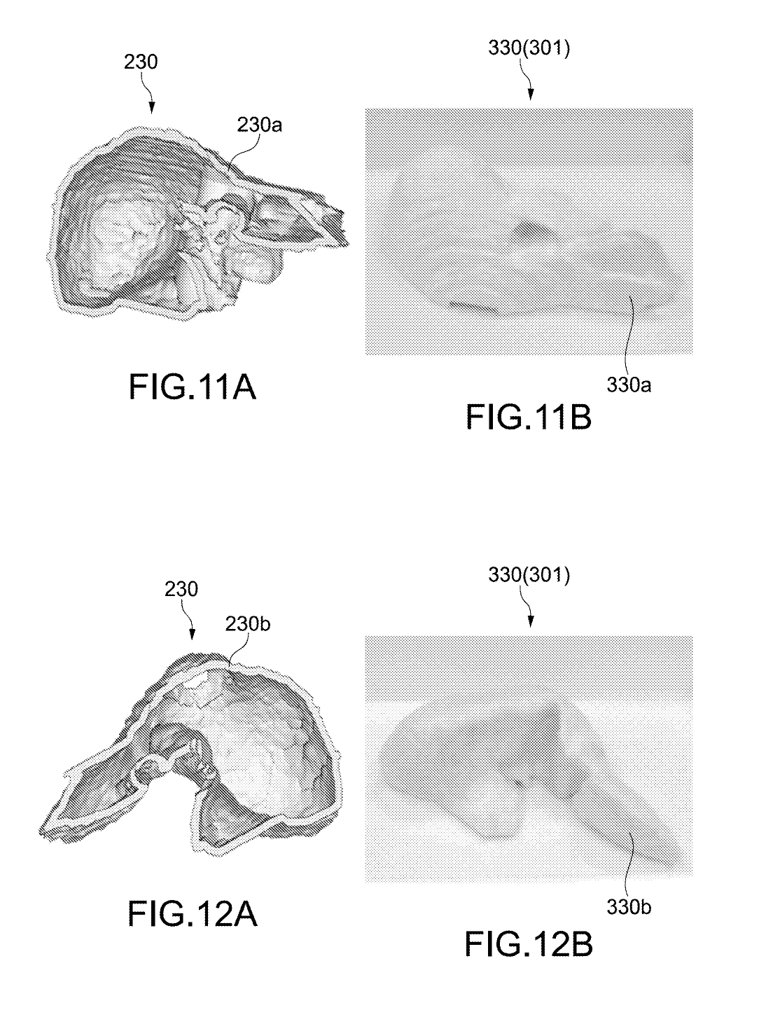

FIGS. 11A-11B and FIGS. 12A-12B are each a diagram for explaining the forming of an outer portion according to this embodiment. In this embodiment, the outer portion is formed so as to resemble a liver.

Based on the three-dimensional image data of the outer portion of the liver 220 generated in step 103 in FIG. 7, a slice image for molding is generated and a liver portion 330 is formed. Specifically, from the image data of the liver 220, data of a surface portion 230 of the liver 220, which has a thickness of about 5 mm, is generated. Therefore, data of the hollow liver 220 is generated. Moreover, in this embodiment, the liver 220 is divided into halves and data of the surface portion 230 is generated. If the portion shown in FIGS. 11A-11B is assumed to be the right side, data of a right surface portion 230a is generated as shown in FIG. 11A. If the portion shown in FIGS. 12A-12B is assumed to be the left side, data of a left surface portion 230b is generated as shown in FIG. 12A (steps 104 and 105).

Based on the data for molding of the right surface portion 230a and the left surface portion 230b generated in step 105, the liver portion 330 is formed as a model of the surface portion 230 (step 106). As shown in FIG. 11B, the right portion of the liver portion 330 is formed as a model of the right surface portion 230a (hereinafter, referred to as a right divided portion 330a). Moreover, as shown in FIG. 12B, the left portion of the liver portion 330 is formed as a model of the left surface portion 230b (hereinafter, referred to as a left divided portion 330b). These portions correspond to the outer portion 301 in this embodiment. As described above, in this embodiment, the outer portion 301 is formed so as to have internal space.

As described above, additive manufacturing of the right divided portion 330a and the left divided portion 330b is performed by using a material including salt as a main component. The portions are formed as a molded article that is soluble in a solvent including water as a main component. It should be noted that another material such as ethanol may be used as the solvent. Then, the right divided portion 330a and the left divided portion 330b may be formed of a material that is soluble in the solvent. Moreover, the additive manufacturing technology used for forming the right divided portion 330a and the left divided portion 330b is not also limited. In addition to the method of producing the powder, an optical molding method, a sheet additive manufacturing method, or a fused deposition modeling (FDM) method may be used, for example. Furthermore, the outer portion 301 may be formed by another technology other than the additive manufacturing technology.

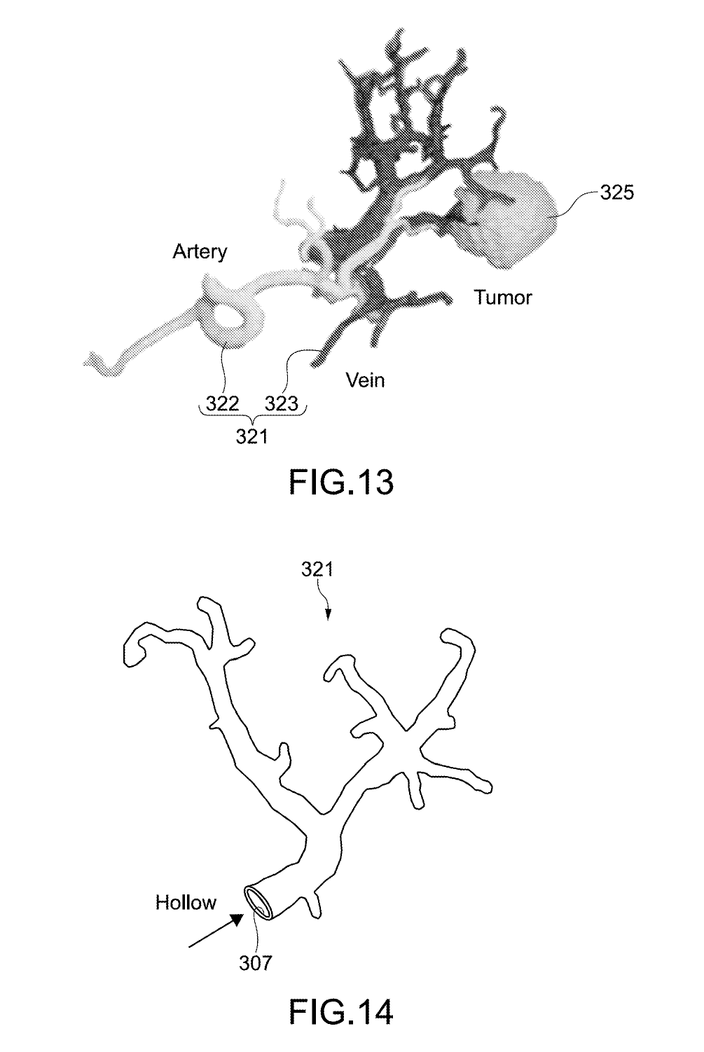

FIG. 13 is a photograph showing models of a blood vessel and a tumor serving as a molded body according to this embodiment. Based on the three-dimensional image data of the blood vessel 221 and the tumor 225 generated in step 103 in FIG. 7, data for molding is generated. For example, as described above, data of an image that is color-coded for each portion is generated. Moreover, data of an image in which a predetermined portion is hollow is generated as necessary. In this embodiment, a hollow molded body is formed like an actual blood vessel as a model of the blood vessel 221. Therefore, data of an image in which the blood vessel 221 is hollow is generated (steps 107 and 108).

Based on the data for molding of the blood vessel 221 and the tumor 225 generated in step 108, molding models are generated (step 109). Hereinafter, the molding models of the blood vessel 221 and the tumor 225 will be described as a blood vessel portion 321 (artery portion 322 and vein portion 323) and a tumor portion 325. The blood vessel portion 321 and the tumor portion 325 are formed of a molding material that is insoluble in a solvent. In this embodiment, the portions are formed of a non-water-soluble material. The method of forming the blood vessel portion 321 and the like is not limited. For example, the molding apparatus 100 may be used to form the blood vessel portion 321 and the like by using a powder molding method. In this case, the blood vessel portion 321 and the like may be formed during the forming of the liver portion 330 being the outer portion 301 described above. Alternatively, the blood vessel portion 321 and the like may be formed at timing different from that of the forming of the liver portion 330. Moreover, another additive manufacturing technology may be used to form the blood vessel portion 321 and the like. Alternatively, another technology such as injection molding may be used.

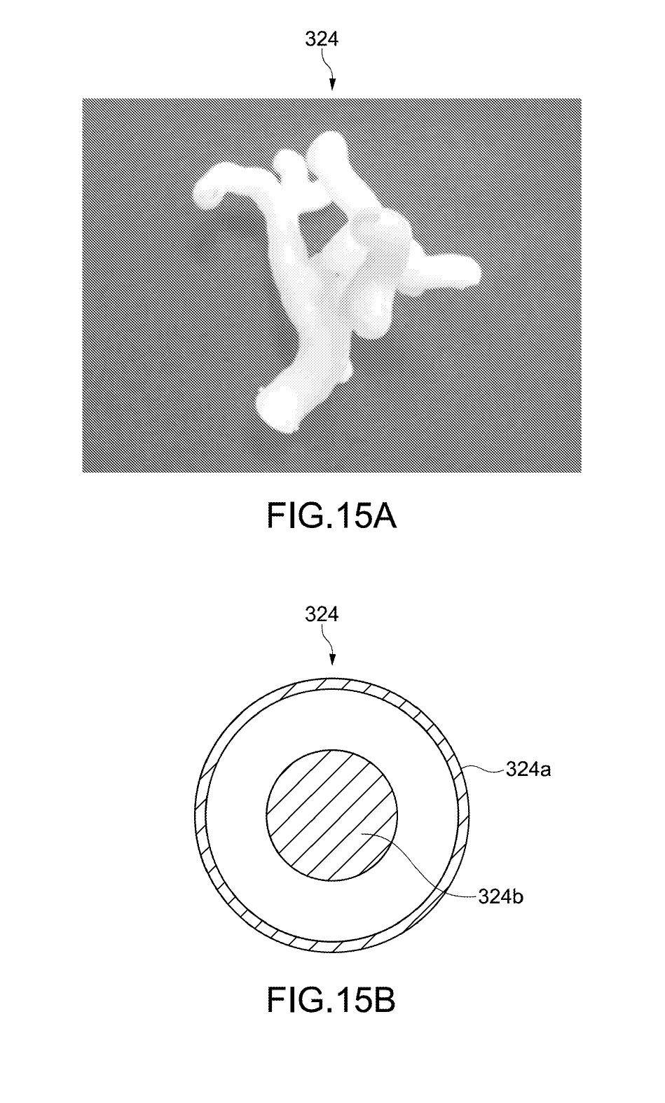

FIG. 14 and FIGS. 15A-15B are a diagram and a photograph for explaining the blood vessel portion 321 formed so as to resemble the blood vessel 221 and to be hollow, respectively. For example, the blood vessel portion 321 including a hollow portion 307 shown in FIG. 14 may be directly formed by an additive manufacturing technology or the like based on the data for molding of the blood vessel 221. On the other hand, as shown in FIG. 15A, a mold 324 for forming the blood vessel portion 321 may be formed from the data for molding of the blood vessel 221. As shown in FIG. 15B, on the cross-section of the mold 324, a surface portion 324a determining the outer shape of the blood vessel portion 321 and a central portion 324b corresponding to the hollow portion 307 of the blood vessel portion 321 are formed. For example, a non-water-soluble material such as silicone is poured between the surface portion 324a and the central portion 324b, and thus the hollow blood vessel portion 321 is formed. In this way, the blood vessel portion 321 may be formed.

By forming the hollow blood vessel portion 321, it is also possible to reproduce the state where blood, a contrast medium, or the like flows through the real blood vessel, for example. Moreover, it is possible to form a molded article that is useful for surgery simulation or the like. Although described alter, during the surgery simulation, for example, it is possible to inject liquid such as a contrast medium and colored ink that resembles the contrast medium as in the case of the actual surgery, disperse the liquid, color the affected areas, and identify a portion to be resected.

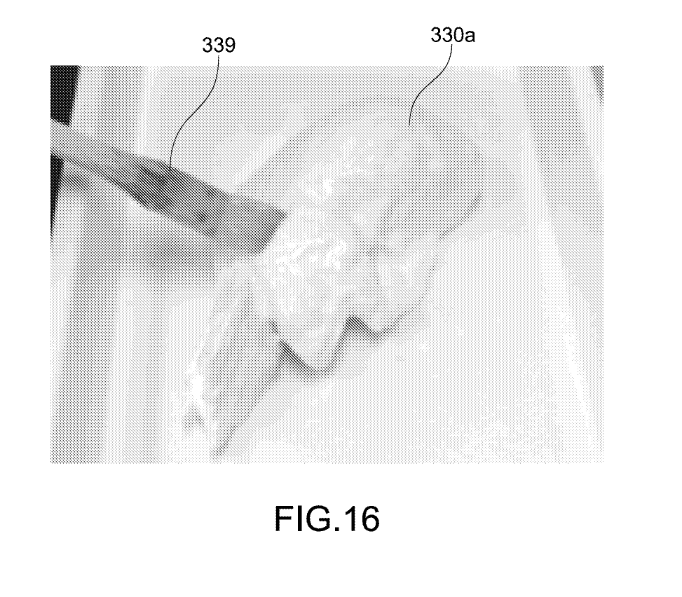

FIG. 16 is a photograph showing a process of applying wax to the right divided portion 330a and the left divided portion 330b formed as the outer portion 301. The right divided portion 330a and the left divided portion 330b formed in step 106 may be formed as they are as the outer portion 301 being a dissolving mold. On the other hand, a step or a concavity and convexity remains on the surface of a molding model produced by additive manufacturing using powder as in this embodiment in most cases. Therefore, in order to fill this, filling up of a hole for smoothing the concavity and convexity, which is called filling, is performed using water-soluble wax. It is possible to increase the strength of the outer portion 301 by applying the wax for the filling up of a hole. Specifically, it is possible to reinforce the outer portion 301 (step 110).

In the example shown in FIG. 16, a brush 339 is used to apply wax by a manual operation. The method applying wax to the right divided portion 330a and the left divided portion 330b is not limited thereto. For example, wax may be automatically sprayed by using an applying apparatus such as a spray. In addition, any applying method can be used. Moreover, the material of the wax is not also limited.

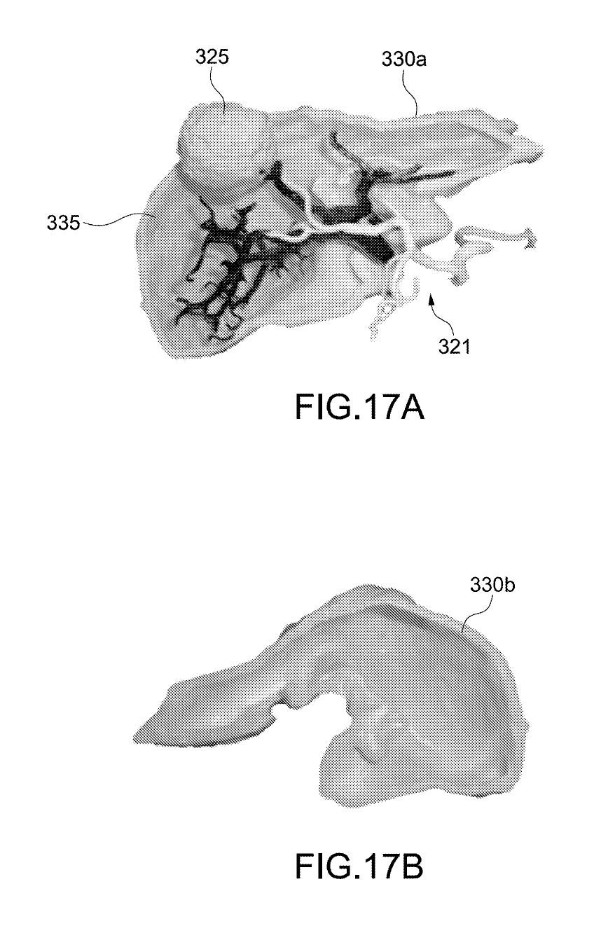

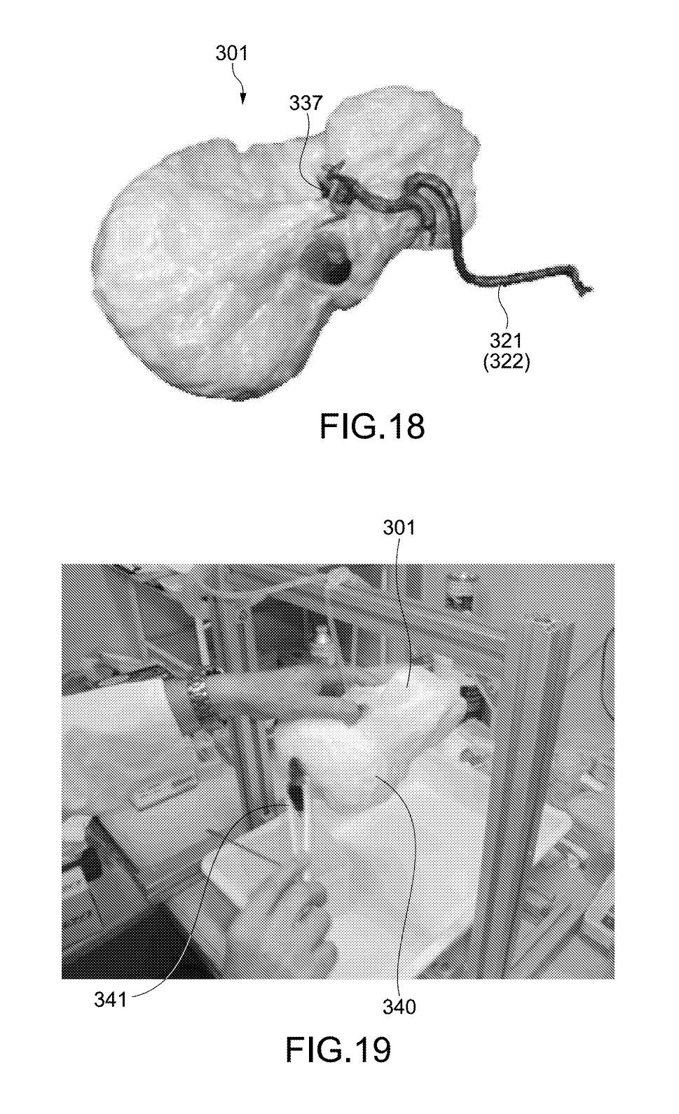

FIGS. 17A-17B and FIG. 18 are each a photograph for explaining the assembly of the outer portion 301 formed as a model of the surface portion 230. After the right divided portion 330a and the left divided portion 330b are reinforced by water-soluble wax, the blood vessel portion 321 and the tumor portion 325, which are internal models, are disposed in one of the divided portions. In this embodiment, as shown in FIG. 17A, the blood vessel portion 321 and the tumor portion 325 are disposed in the internal space 335 of the right divided portion 330a. Then, the left divided portion 330b shown in FIG. 17B is overlapped with the right divided portion 330a, and the portions are united. Accordingly, the internal model is sandwiched between the right divided portion 330a and the left divided portion 330b (step 111). As a result, as shown in FIG. 18, the outer portion 301 in which the blood vessel portion 321 and the like are disposed in the internal space 335 is formed. As shown in FIG. 18, a passage hole 337 through which the blood vessel portion 321 passes is formed in the outer portion 301.

In this embodiment, water-soluble wax is used as an adhesive to attach the right divided portion 330a and the left divided portion 330b with each other. By applying wax to a united portion in which the respective units are attached to each other, filling up of a hole for smoothing the step and the concavity and convexity is also performed simultaneously (step 112 in FIG. 8). It should be noted that the method of uniting the right divided portion 330a and the left divided portion 330b and the type of the adhesive or the like used for the method are not limited.

FIG. 19 is a photograph showing a process of forming a covering portion according to this embodiment. As shown in FIG. 19, in this embodiment, silicone for molding is applied as the first flexible material so as to cover the formed outer portion 301 (step 113). Accordingly, a covering portion 340 is formed. As shown in FIG. 19, the covering portion 340 is formed of a material through which visible light is transmitted, i.e., transparent material. Hereinafter, the covering portion 340 is described as a silicone film 340 in some cases.

In the example shown in FIG. 19, silicone is applied using a brush 341 by manual operation. However, the applying method is not limited. For example, silicone may be automatically applied by using an applying apparatus such as a spray. Moreover, the type of the first flexible material is not limited as long as it is insoluble in a solvent, i.e., water-insoluble. For example, rubber in the form of liquid may be applied, or rubber may be sprayed by a spray. In addition, another flexible material may be used.

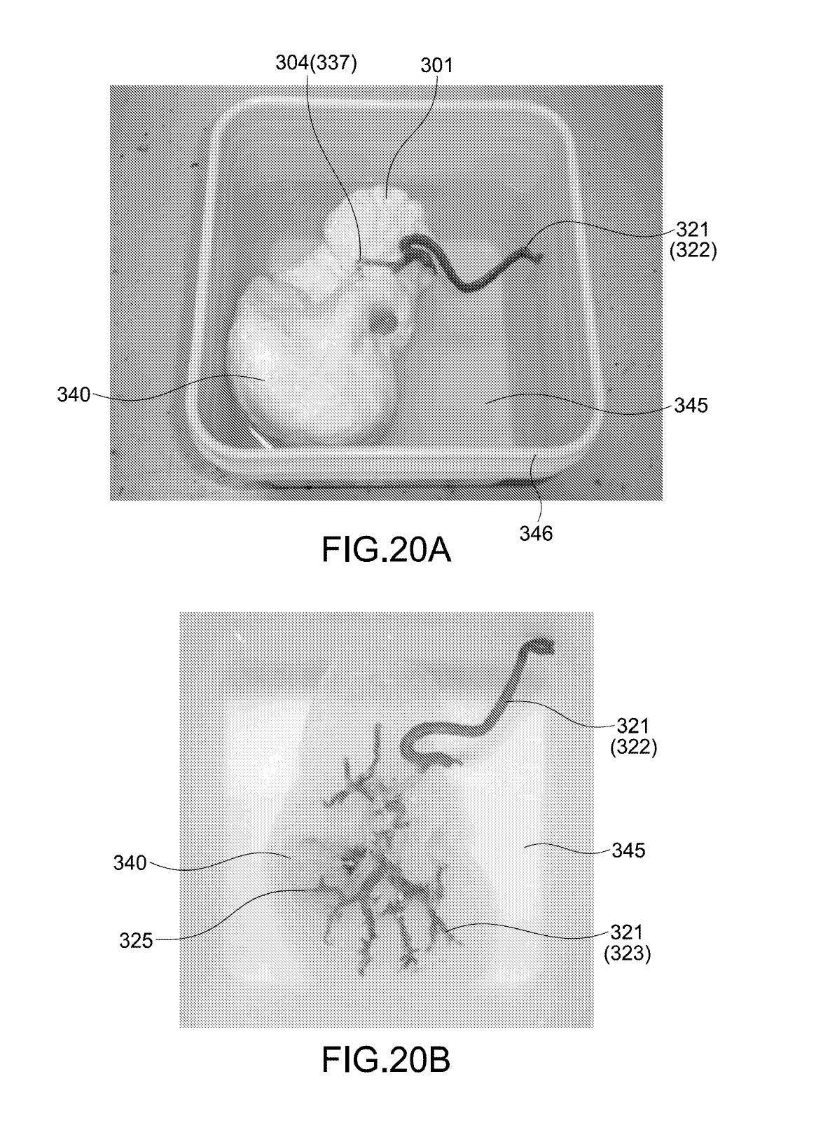

FIGS. 20A-20B are each a photograph showing a process of dissolving the outer portion 301 according to this embodiment. As shown in FIG. 20A, the outer portion 301 covered by the covering portion 340 including silicone is put in water (hot water) 345 being a solvent (step 114). Hot water having a temperature of about 60° C. may be used so that the outer portion 301 and water-soluble wax applied for the filling up of a hole are easy to be dissolved. In this embodiment, silicone is formed in the entire area around the outer portion 301. Therefore, the opening 304 is formed at a predetermined position so that the hot water 345 can enter the outer portion 301. The opening 304 is formed at an obscure position or a position that does not affect surgery simulation or the like. In this embodiment, the opening 304 is formed at a position corresponding to the passage hole 337 of the blood vessel portion 321.

The method of dissolving the outer portion 301 in a solvent is not limited. As in the case of this embodiment, the outer portion 301 may be dissolved by putting the outer portion 301 in a container 346 in which the hot water 345 is put. In addition, by injecting the hot water 305 in the outer portion 301 via the opening 304, the outer portion 301 may be dissolved. It should be noted that also in the case where another material such as ethanol is used as a solvent, the method of putting the outer portion 301 in a solvent described here may be performed, for example.

As shown in FIG. 20B, when the hot water 345 being a solvent enters from the opening 304 and dissolves the outer potion 301, the silicone film 340 being a covering portion, the internal blood vessel portion 321, and the tumor portion 325 remain in the container 346. In this embodiment, as the first flexible material, a material through which visible light is transmitted, i.e., transparent material is used. Therefore, from the outside of the silicone film 340, the internal blood vessel portion 321 or the like can be seen through. It should be noted that in this embodiment, the outer portion 301 dissolves in from about 30 minutes to 1 hour. The time for dissolving is changed depending on the solvent, the material of the outer portion 301, or the like.

As shown in FIG. 19 and FIGS. 20A-20B, in this embodiment, the process of forming the covering portion 340 and the process of dissolving the outer portion 301 are performed in a state where the blood vessel portion 321 or the like being the molded body is disposed in the internal space 335 of the outer portion 301.

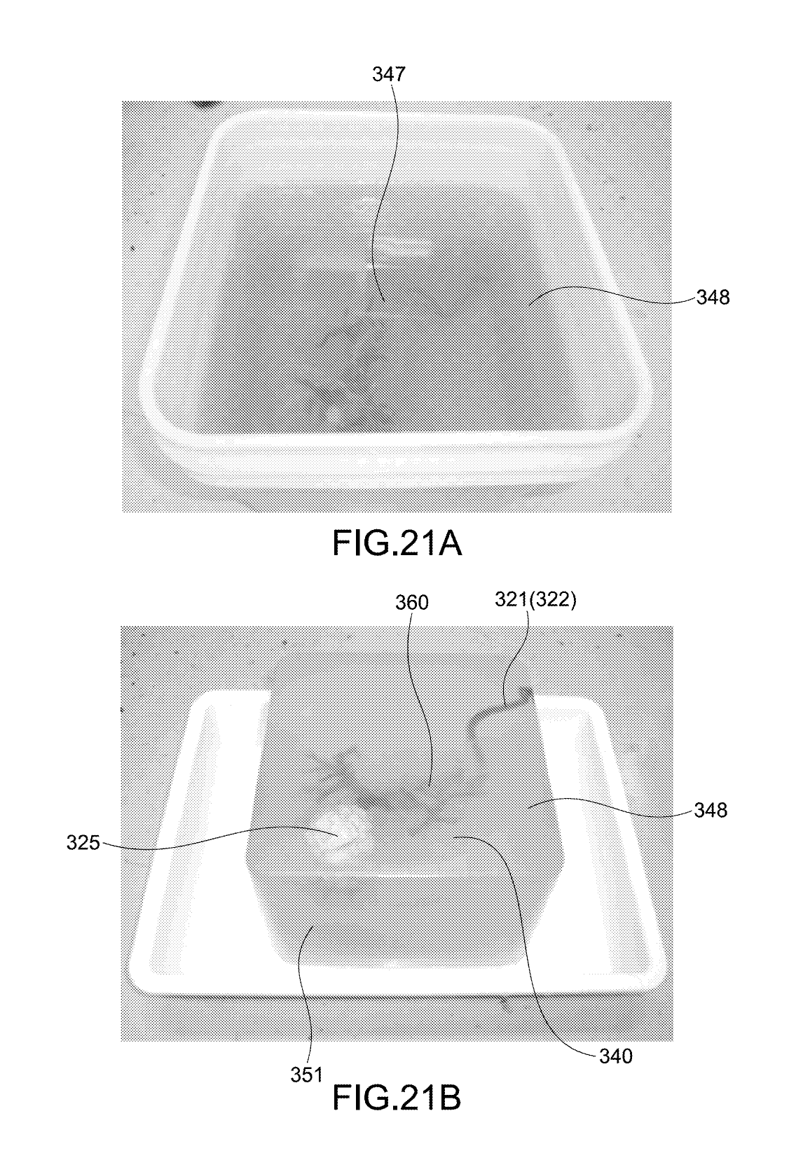

FIGS. 21A-21B are each a photograph showing a process of filling a second flexible material according to this embodiment. As shown in FIG. 21A, the outer portion 301 dissolves, molding models 347 including the silicone film 340, the blood vessel portion 321, and the tumor portion 325 are put in a solution of a gelatin 348 serving as the second flexible material (step 115). Then, the gelatin 348 permeates the area covered by the silicone film 340 via the opening 304. In this embodiment, the gelatin aqueous solution naturally permeates and is filled in the inside area by the atmospheric pressure. At this time, the internal air is released to the outside. As shown in FIG. 21A, the filling process according to this embodiment is performed in a state where the blood vessel portion 321 or the like being the molded body is disposed in the area covered by the covering portion 340.

The method of filling the second flexible material in the covering portion 340 is not limited. For example, the second flexible material may be filled in the covering portion 340 by using a syringe or the like. Moreover, the second flexible material may be filled in the internal area after the pressure in the covering portion is reduced by vacuuming or the like. In addition, various technologies may be used.

As shown in FIG. 21B, the internal air is evacuated, the process of refrigerating or the like is performed, and the gelatin 348 is cured (step 116). Because the silicone film 340 maintains the outer shape of the liver, a lump 351 in the state where a liver model 360 according to this embodiment is embedded in the gelatin 348 is formed. A cross-linking agent may be added to cure the gelatin 348. The gelatin 348 may be cross-linked by heating, and after that the gelatin 348 may be cured by cooling. Accordingly, the heat-resistance is improved as compared with the gelatin 348 cured by only refrigerating. In addition, addition of a coagulant or heat treatment may be appropriately performed to cure the second flexible material. The amount of the cross-linking agent may be adjusted to adjust the hardness of the gelatin 348. Accordingly, for example, it is possible to form the liver model 360 having the hardness depending on the development of cirrhosis of liver.

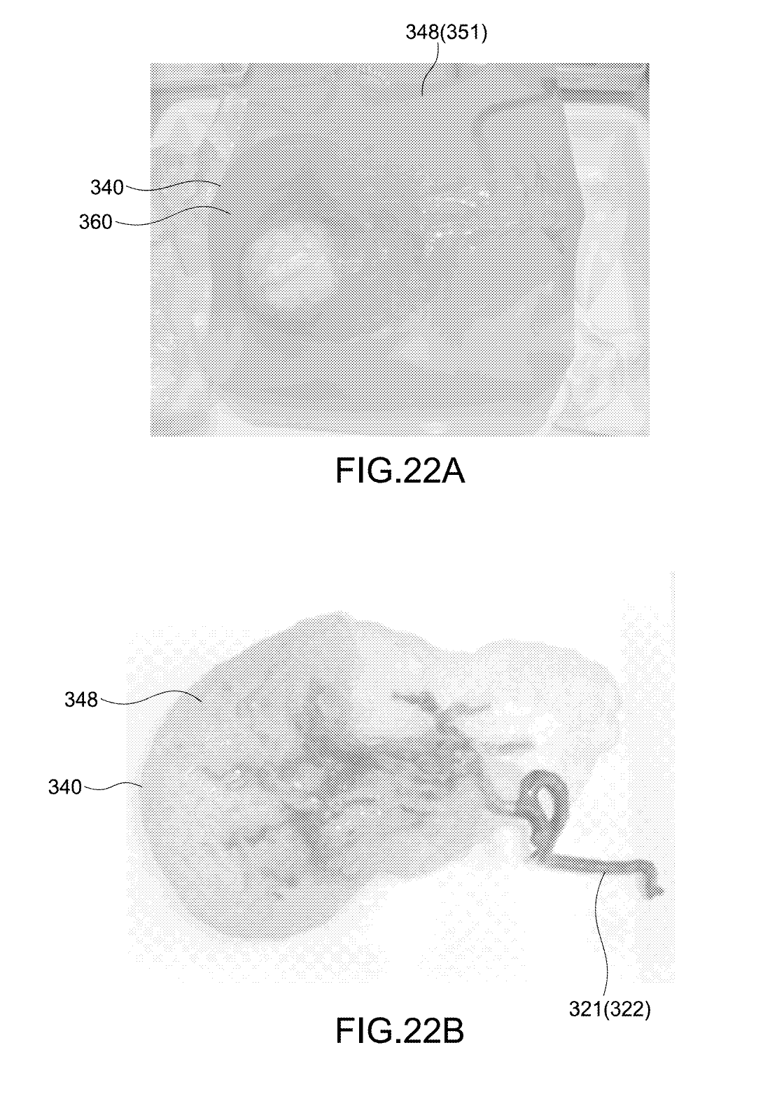

FIGS. 22A-22B are each a photograph showing a process of extracting the liver model 360 from the lump 351 of gelatin 348. As shown in FIGS. 22A-22B, the unnecessary gelatin 348 on the outside of the liver model 360, i.e., outside of the silicone film 340, is gradually removed (step 117). The method of removing the gelatin 348 is not limited. Accordingly, as the molded article according to this embodiment, the liver model 360 is completed (step 118).

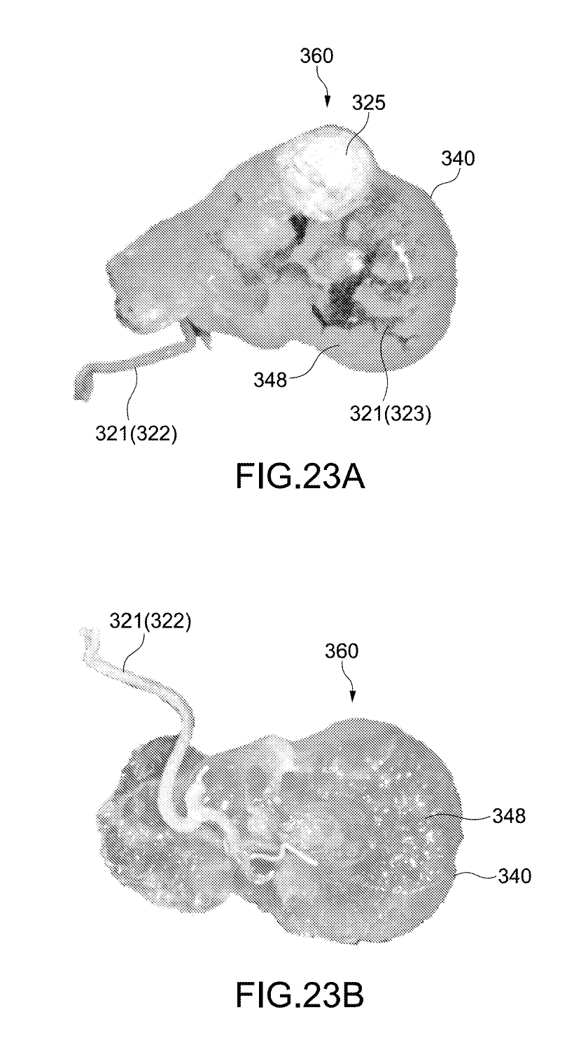

FIGS. 23A-23B are each a photograph showing the completed liver model 360. The gelatin 348 is filled in the silicone film 340 that forms the outside shape of the liver as the second flexible material. Moreover, in the gelatin 348, the blood vessel portion 321 and the tumor portion 325, which are formed as the molded body, are included. Accordingly, the liver model 360 being a soft object is produced as a molded body with high reproducibility. By appropriately selecting a material or the like, it is possible to produce the liver model 360 so as to resemble the real thing with high precision with respect to the outer shape, the internal structure, the feeling, and the like.

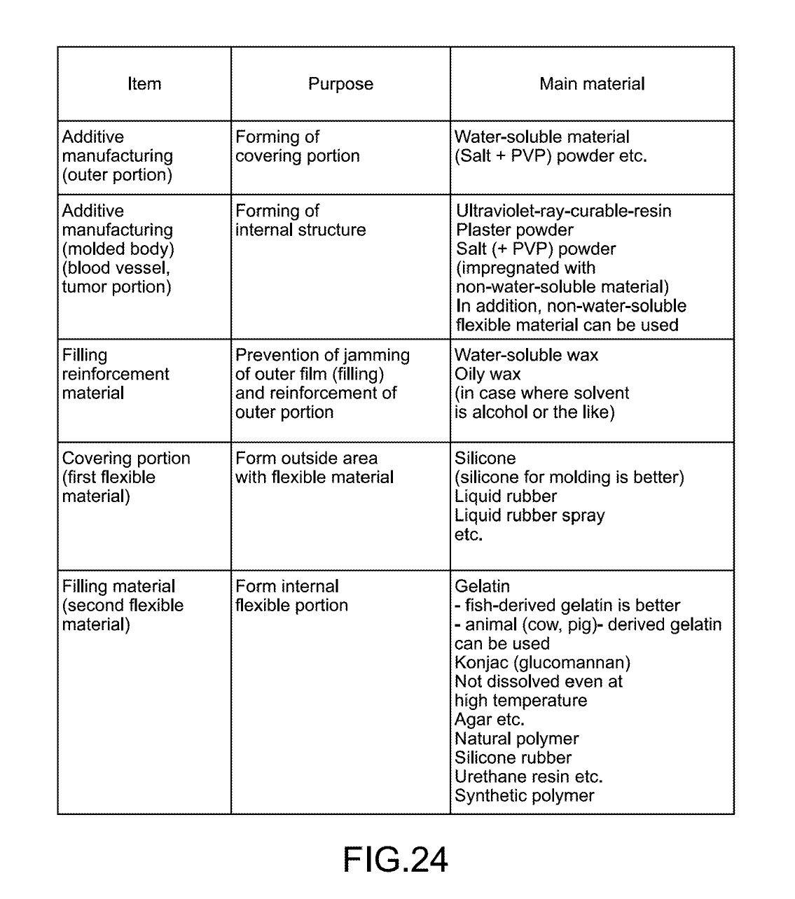

FIG. 24 is a table showing examples of the outer portion, a molded body disposed in the outer portion, a filling reinforcement material applied to the outer portion, a first flexible material to be the covering portion, and a second flexible material to be filled in the inside area. In the table shown in FIG. 24, the examples described above are also described.

As shown in FIG. 24, various modified examples are conceivable as an example of the present disclosure. For example, as the second flexible material to be filled in the inside area, natural polymers such as gelatin, agar, and konjac may be used. On the other hand, as the second flexible material, synthetic polymers such as silicone and urethane may be used. Moreover, the powder used for the additive manufacturing of the outer portion or the combination of materials of the outer portion may be different from those described above. Furthermore, a non-substantial material, which does not change the substantial function, may be added to the composition of each material.

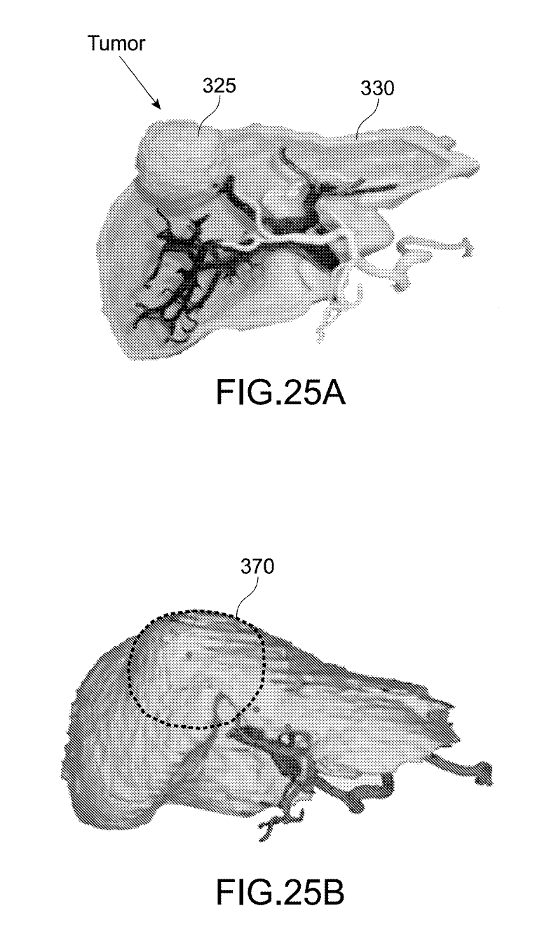

The forming of the resection area portion will be described with reference to FIGS. 25 to 27. In the case where a tumor in an organ is resected in actual surgery, an area larger than the tumor, which includes the tumor, is often resected. For example, a contrast medium or the like is injected through a blood vessel, and affected areas including a tumor and a resection area for resecting the tumor are emphasized.

In this embodiment, in the case where a tumor portion is formed as a molded body so as to resemble a biological tissue, the resection area portion is formed as an area for resecting the tumor portion. The resection area portion represents the resection area described above.

As shown in FIG. 25A, the tumor portion 325 is formed in the liver portion 330. In this case, as shown in FIG. 25B, the resection area portion 370 is formed in an area larger than the tumor portion 325 (area surrounded by dashed line), which includes the tumor portion 325. Accordingly, it is possible to produce the liver model 360 that is useful for surgery simulation.

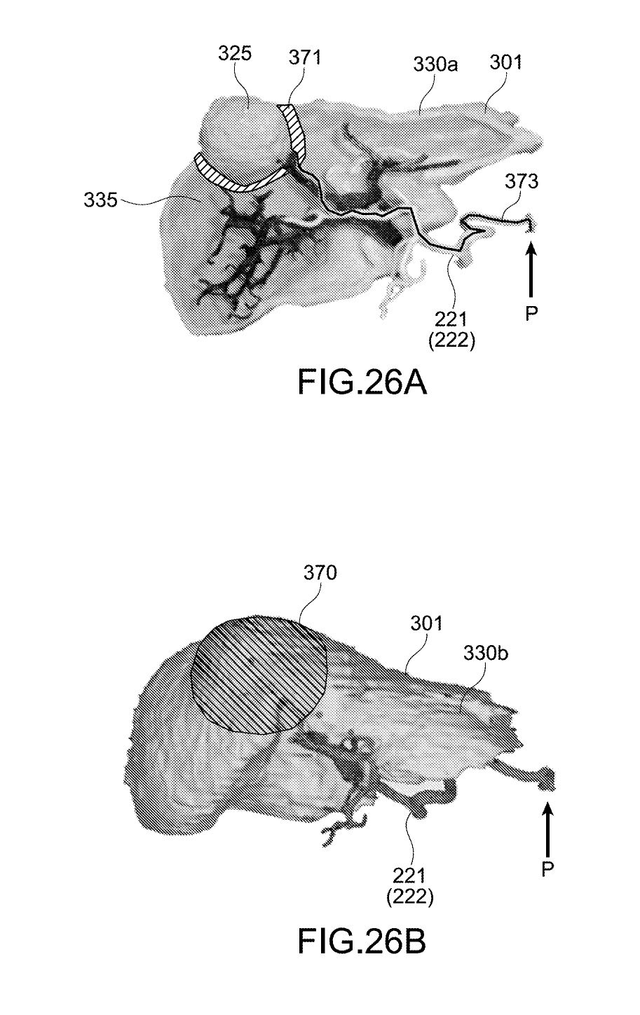

FIGS. 26A-26B are each a diagram showing an example of a method of forming the resection area portion 370. In the example shown in FIGS. 26A-26B, a material 371 for the resection area portion is provided around the tumor portion 325 so as to cover the tumor portion 325. The material 371 for the resection area portion typically includes a fiber-like material such as a melamine form, absorbent cotton, cloth, pulp, and cotton, and a material colored by a predetermined staining material such as ink.

As shown in FIG. 26A, in the state of being covered by the material 371 for the resection area portion, the tumor portion 325 is disposed in the internal space 335 of the outer portion 301. Then, as shown in FIG. 26B, the tumor portion 325 is sandwiched between the right divided portion 330a and the left divided portion 330b to be the outer portion 301 (step 111 in FIG. 7). In the state, silicone is applied in step 113, and thus the covering portion 340 is formed. Moreover, in step 114, the outer portion 301 is dissolved in a solvent. It should be noted that as the material 371 for the resection area portion, a material that is insoluble in a solvent is selected. In step 115, the gelatin 348 is filled in the area covered by the covering portion 340. Accordingly, in the gelatin 348, the tumor portion 325 is covered by the resection area portion 370 including a fiber material.

Therefore, in the example shown in FIG. 26, the process of forming the resection area portion 370 is performed by covering the tumor portion 325 with the material 371 for the resection area portion during the process of disposing the tumor portion 325 and the like, forming the covering portion 340 in the state, dissolving the outer portion 301, and filling the second flexible material. It only needs to provide the material 371 for the resection area portion so as to cover the tumor portion 325, and to progress the process in the state. Therefore, it is possible to easily form the resection area portion 370.

As shown in FIG. 26A, the hollow blood vessel portion 321 through which the staining material 373 is capable of flowing is formed so as to connect to the resection area portion 370 formed of the material colored with the staining material 373. Accordingly, as shown in FIG. 26B, when the staining material 373 is injected into the hollow portion of the blood vessel portion 321 (see arrow P), the staining material 373 reaches the resection area portion 370, and the resection area portion 370 is colored and emphasized. As a result, it is possible to simulate the action of injecting a contrast medium from a blood vessel to stain a tumor portion.

It should be noted that FIG. 26B is a diagram showing a state where the tumor portion 325 is sandwiched between the outer portion 301. FIG. 26B is used to describe the forming of the resection area portion 370, and coloring of the resection area portion 370. Actually, the second flexible material is filled in the area in which the outer portion 301 is dissolved, and thus the liver model 360 is completed. In the completed liver model, the resection area portion 370 is colored via the blood vessel 221. Because the completed liver model 360 includes the transparent covering portion, it is sufficiently possible to observe the state where the staining material 373 flows through the blood vessel portion 370, the state where the resection area portion 370 is colored, or the like.

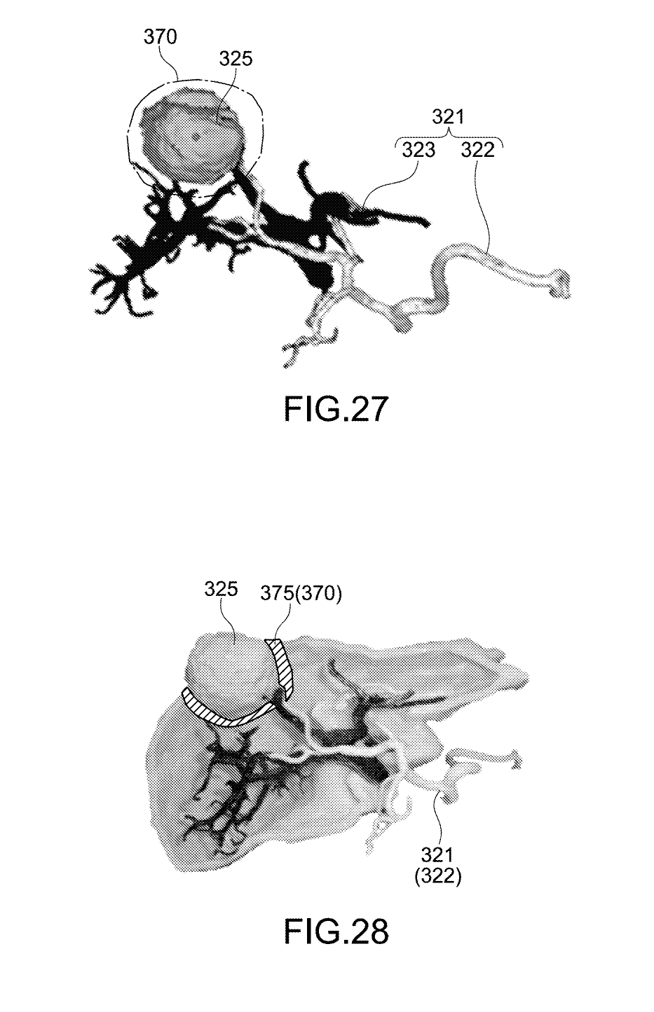

FIG. 27 is a diagram showing another example of the method of forming the resection area portion 370. In the example shown in FIG. 27, when the blood vessel portion 321 and the tumor portion 325 are molded based on the CT image or the like, the resection area portion 370 is molded simultaneously. Specifically, in the example shown in FIG. 27, the process of forming the resection area portion 370 is performed by forming the tumor portion 325 and the resection area portion 370 including the tumor portion 325.

For example, data of the area including a tumor based on the data of the tumor may be generated, and the resection area portion 370 may be molded based on the data. Alternatively, simply, an area slightly larger than the tumor portion 370 may be molded. The resection area portion 370 and the tumor portion 325 formed therein may be separately formed, and only the resection area portion 370 including the tumor portion 325 may be formed. Moreover, also in the case where the blood vessel portion 321 and the tumor portion 325 are formed by a method different from the additive manufacturing method, the resection area portion 370 may be formed simultaneously. The resection area portion 370 is formed during the process of forming of the tumor portion 325 serving as a molded body. Therefore, it does not need to add a process for forming the resection area portion 370 exceptionally, and thus it is possible to reduce the number of processes.

FIG. 28 is a diagram showing another example of the method of forming the resection area portion 370. In the example shown in FIG. 28, the flexible material 375 for the resection area portion 370 is used during the filling of the second flexible material in step 114. For example, before gelatin is filled in the inside area and the gelatin is cured, konjack (glucomannan) is injected around the tumor portion 325 by a syringe or the like. Thus, the resection area portion 370 is formed. As described above, different types of flexible materials may be used for each area. As the different types of flexible materials, any flexible material may be selected.

Specifically, in the example shown in FIG. 28, the process of forming the resection area portion 370 is performed by preparing a plurality of types of flexible materials as the second flexible material during the process of filling the second flexible material, filling the flexible material 375 for the resection area portion around the tumor portion 325, and filling a flexible material different from the flexible material 375 for the resection area portion in another area. The method of filling the flexible material 375 for the resection area portion around the tumor portion 325 is not limited.

It should be noted that in the case where the resection area portion 370 is formed by the method shown in FIG. 27 and FIG. 28, the resection area portion 370 may be formed so as to include a material colored by a staining material. For example, the resection area portion 370 is formed so that a fiber material such as gauze is embedded. Alternatively, a fiber material is provided around the tumor portion 325 during the filling of the flexible material 375 for the resection area portion, and thus the resection area portion 370 is formed. In addition, the method of making the inside area to include a fiber material or the like is not limited.

The hollow blood vessel portion 321 described above is formed so as to connect to the resection area portion 370 including a material colored by a staining material. Accordingly, it is possible to simulate the action of injecting a contrast medium from a blood vessel to stain a tumor portion.

In the method of producing the molded article according to this embodiment, the outer portion 301 having a predetermined shape is formed, and the covering portion 340 that covers the outer portion 301 is formed of the first flexible material. The outer portion 301 is dissolved with a solvent, and the second flexible material is filled in the area covered by the covering portion 340. As a result, it is possible to produce the liver model 360 having high reproducibility with respect to the appearance and the internal structure.

The technology for forming a molded article using an additive manufacturing apparatus has been known in the past, and molded articles in various forms are formed depending on the original material. For example, an apparatus using an optical molding method uses ultraviolet-ray-curable resin. Therefore, an almost transparent hard or soft molded article is attained. In a powder molding method using plaster, a molded article whose surface is colored can be obtained. The forming of an organ model that uses an organ or the like as a target object to be molded is also performed. For example, examples of the organ model include a model obtained by optical molding. Moreover, a method of circulating a material using a mold die to prepare an organ has been known.

For example, a method of preparing a mold of a human body by multilayer molding (additive manufacturing) based on the CT image has been generally performed. As the method, there is a method of preparing a mold of a human body using different type of light curable resin as a material for molding. However, in the method, the material is largely limited, and it is substantially difficult to obtain a molded article that simulates a human body. Although a method of combining molding methods generally used to prepare a mold of a human body is conceivable, it is not practical from the viewpoint of cost and possibility, and it is often difficult to obtain a desired molded article.

Moreover, a frame using wood or hard plastic whose surface layer is covered by a soft member such as silicone has been known as a model of human body. For example, a soft dummy representing a part of a human body by using form resin beads for chest region (mammary region) has been used. Although the method is suitable for the research and development of clothes, it seems that it is close but not the same as a medical simulation model that targets a particular character or a patient.

The method of producing an organ model by optical molding has problems such as taking a lot of time, high cost of material, and limitation of usable material. Specifically, there has been a problem of costing too much as a model of a personal organ. In the case where a mold is prepared, although the cost of the material of the mold is low, it takes a lot of time to prepare the mold. Thus, the mold itself becomes expensive. Therefore, in the case where many same models are not produced, it becomes substantially expensive. Moreover, if a complicated model such as an organ is produced, a problem of difficulty of producing the complicated mold by a molding method is caused, for example.

In view of such a problem, there is a need to produce a transparent soft model of a personal organ at a low cost. The method of producing a molded article according to this embodiment described above is effective in this point. Specifically, the outer portion determining the outer shape of an organ or the like is formed as a dissolving mold. The outer film is formed of the first flexible material on the outer portion. Accordingly, the outer shape is transferred to the covering portion. The outer portion is dissolved and is replaced with the second flexible material while leaving the colored portion of the blood vessel or the tumor portion. Accordingly, it is possible to produce a model of an organ whose surface is soft and whose blood vessel or tumor can be seen through at a low cost.

Because it is possible to form a model of an organ so that the inside of the model can be observed, it is very useful for surgery simulation using the model of an organ or for explanation to a patient. Moreover, it is possible to easily secure the internal cavity by using the outer portion as the dissolving mold. As a result, it is possible to form a molded article, which resembles the real thing more, with high reproducibility. Moreover, it is possible to easily form a molded article that is useful for surgery simulation.

Moreover, it is also possible to protect the second flexible material in the internal region by the covering portion. Accordingly, it is possible to prevent the drying or the like of the second flexible material, and to maintain the strength of the molded article. Moreover, it is possible to prolong the lifetime of the molded article.

### Other Embodiments

The present disclosure is not limited to the above-mentioned embodiments, and other various embodiments can be achieved.

In the embodiment described above, a molded article such as a model of an organ, which is used in a medical field, is produced. However, the method of producing a molded article according to the present disclosure can also be applied to producing of a molded article according to another field, of course. Specifically, the scope in which the present disclosure can be applied is not limited.

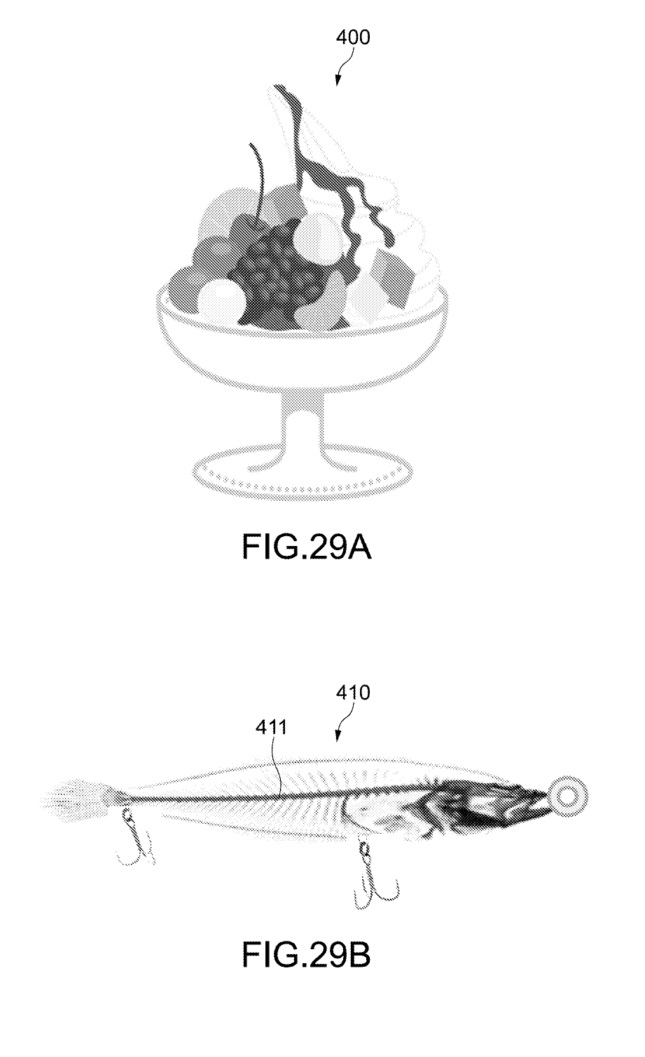

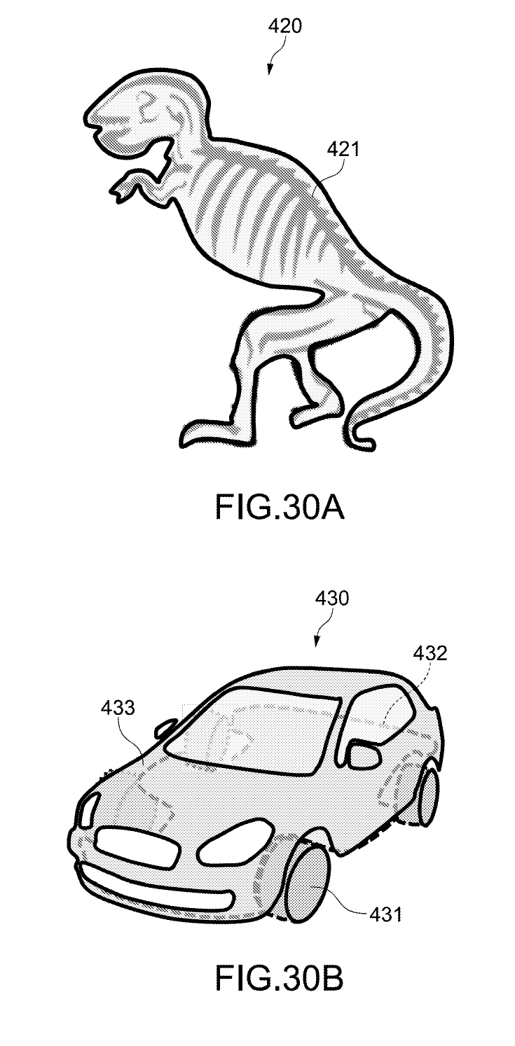

FIGS. 29A-29B and FIGS. 30A-30B are each a diagram showing an example of a molded body according to various fields, which is produced with high reproducibility in the present disclosure. For example, as shown in FIG. 29A, it is possible to produce a food product sample 460 including a seed or a hard portion such as a fruit and “mitsumame” (Japanese dessert) with high reproducibility. The hard portion only has to be formed as in the above-mentioned blood vessel portion or the like. Soft portions such as flesh of fruits only have to be formed of the first and second flexible materials. It is possible to produce various food product samples 400 such as fruits including a grape and an orange.

As shown in FIG. 29B, it is possible to produce a model 410 including a skeleton 411 such as fish and a lure with high reproducibility. It is also possible to produce a model of another organism.

FIG. 30A is a diagram showing a toy 420 formed so as to resemble a dinosaur. For example, the skeleton 421 or the like may be formed of a hard material as a molded body, and the second flexible material may be filled so as to cover the skeleton 421 or the like. By forming the covering portion with the transmission-type first flexible material, it is possible to produce the toy 420 with high designability whose skeleton can be seen from the outside. Moreover, it is possible to easily attain a structure in which the skeleton 421 includes a joint portion and a limb or the like can be bent by the joint portion, for example.

FIG. 30B is a diagram showing a toy 430 formed so as to resemble an automobile. For example, a tire 431 or a frame 432 on the lower portion is separately formed as a molded body. Then, a body portion 433 is formed by filling a flexible material such as gelatin (second flexible material) so as to cover them. On the surface, a silicone film is formed as the covering portion, for example.

In addition, by using a machine, an apparatus, a component, and the like used in various industry fields as a molding target, it is possible to produce a molded article with high reproducibility.

The molding apparatus 100 is an example of an apparatus performing additive manufacturing using a powder material, and various modification can be made without departing from the gist of the present technology on the structure of the apparatus.

Out of the features of the embodiments described above, at least two features can be combined.

It should be noted that the present disclosure may also take the following configurations.

(1) A method of producing a molded article, including

forming an outer portion of a material that is soluble in a solvent, the outer portion having a predetermined shape;

forming a covering portion of a first flexible material, the covering portion covering the outer portion, the first flexible material being insoluble in the solvent;

dissolving the outer portion with the solvent, the outer portion being covered by the covering portion; and

filling an area covered by the covering portion with a second flexible material, the area being obtained by dissolving the outer portion.

(2) The method of producing a molded article according to (1), in which

the outer portion is formed by an additive manufacturing technology.

(3) The method of producing a molded article according to (1) or (2), in which

the solvent includes water as a main component, and

the material that is soluble in the solvent includes salt as a main component.

(4) The method of producing a molded article according to any one of (1) to (3), in which

the first flexible material includes a material through which visible light is transmitted.

(5) The method of producing a molded article according to any one of (1) to (4), in which

The first flexible material and the second flexible material include one of a natural polymer and a synthetic polymer as a main component.

(6) The method of producing a molded article according to (5), in which

the first flexible material includes the synthetic polymer as a main component, and

the second flexible material includes the natural polymer as a main component.

(7) The method of producing a molded article according to (5) or (6), in which

the synthetic polymer includes one of silicone rubber and urethane resin, and

the natural polymer includes one of gelatin and konjac.

(8) The method of producing a molded article according to any one of (1) to (7), in which

the outer portion is formed so as to have internal space,

the method of producing a molded article further including
forming a molded body of a molding material that is insoluble in the solvent, and
disposing the formed molded body in the internal space, prior to the forming of the covering portion,
the forming of the covering portion and the dissolving being performed in a state where the molded body is disposed in the internal space, the filling being performed in a state where the molded body is disposed in the area covered by the covering portion.
   (9) The method of producing a molded article according to (8), in which

the outer portion is formed so as to resemble an organ, and

the molded body is formed so as to resemble a biological tissue included in the organ.

(10) The method of producing a molded article according to (9), in which

the biological tissue includes one of a blood vessel and a tumor.

(11) The method of producing a molded article according to (10), in which

the molding body is formed so as to resemble the blood vessel and to be hollow.

(12) The method of producing a molded article according to (10) or (11), further including

forming a resection area portion in a case where the molded body is formed so as to resemble the tumor, the resection area portion being an area for resecting the molded body.

(13) The method of producing a molded article according to (12), in which

the forming of the resection area portion is performed by forming the molded body and the resection area portion during the forming of the molded body, the resection area portion including the molded body.

(14) The method of producing a molded article according to (12), in which

the forming of the resection area portion is performed by, during the filling of the second flexible material,
preparing a plurality of types of flexible materials as the second flexible material,
filling around the molded body with a flexible material for the resection area portion, and
filling other areas with a type of flexible material different from the flexible material for the resection area portion.
   (15) The method of producing a molded article according to any one of (12) to (14), in which

in the forming of the resection area portion, the resection area portion is formed so as to include a material stained with a predetermined staining material, and

in the forming of the molded body, the molded body formed so as to resemble the blood vessel through which the predetermined staining material is allowed to flow and to be hollow is formed so as to connect to the formed resection area portion.

(16) The method of producing a molded article according to (12), in which

the forming of the resection area portion is performed by
forming the covering portion in a state where the molded body is covered with the material for the resection area portion during the disposing of the molded body,
dissolving the outer portion, and
filling the second flexible material.
   (17) The method of producing a molded article according to (16), in which

the material for the resection area portion includes a material stained by a predetermined staining material, and

in the forming of the molded body, the molded body formed so as to resemble the blood vessel through which the predetermined staining material is allowed to flow and to be hollow is formed so as to connect to the resection area portion formed based on the material for the resection area portion.

(18) The method of producing a molded article according to any one of (12) to (17), in which

the resection area portion is formed for surgery simulation for removing a tumor.

It should be understood by those skilled in the art that various modifications, combinations, sub-combinations and alterations may occur depending on design requirements and other factors insofar as they are within the scope of the appended claims or the equivalents thereof.

What is claimed is:

1. A method of producing a molded article, comprising:
forming an outer portion of a material that is soluble in a solvent, the outer portion having a predetermined shape;
forming a covering portion of a first flexible material, the covering portion covering the outer portion, the first flexible material being insoluble in the solvent;
dissolving the outer portion with the solvent, the outer portion being covered by the covering portion; and
filling an area covered by the covering portion with a second flexible material, the area being obtained by dissolving the outer portion.

2. The method of producing a molded article according to claim 1, wherein
the outer portion is formed by an additive manufacturing technology.

3. The method of producing a molded article according to claim 1, wherein
the solvent includes water as a main component, and
the material that is soluble in the solvent includes salt as a main component.

4. The method of producing a molded article according to claim 1, wherein
the first flexible material includes a material through which visible light is transmitted.

5. The method of producing a molded article according to claim 1, wherein
The first flexible material and the second flexible material include one of a natural polymer and a synthetic polymer as a main component.

6. The method of producing a molded article according to claim 5, wherein
the first flexible material includes the synthetic polymer as a main component, and
the second flexible material includes the natural polymer as a main component.

7. The method of producing a molded article according to claim 5, wherein
the synthetic polymer includes one of silicone rubber and urethane resin, and
the natural polymer includes one of gelatin and konjac.

8. The method of producing a molded article according to claim 1, wherein
the outer portion is formed so as to have internal space,
the method of producing a molded article further comprising
forming a molded body of a molding material that is insoluble in the solvent, and
disposing the formed molded body in the internal space, prior to the forming of the covering portion,
the forming of the covering portion and the dissolving being performed in a state where the molded body is disposed in the internal space, the filling being performed in a state where the molded body is disposed in the area covered by the covering portion.

9. The method of producing a molded article according to claim 8, wherein
the outer portion is formed so as to resemble an organ, and
the molded body is formed so as to resemble a biological tissue included in the organ.

10. The method of producing a molded article according to claim 9, wherein
the biological tissue includes one of a blood vessel and a tumor.

11. The method of producing a molded article according to claim 10, wherein
the molding body is formed so as to resemble the blood vessel and to be hollow.

12. The method of producing a molded article according to claim 10, further comprising
forming a resection area portion in a case where the molded body is formed so as to resemble the tumor, the resection area portion being an area for resecting the molded body.

13. The method of producing a molded article according to claim 12, wherein
the forming of the resection area portion is performed by forming the molded body and the resection area portion during the forming of the molded body, the resection area portion including the molded body.

14. The method of producing a molded article according to claim 12, wherein
the forming of the resection area portion is performed by, during the filling of the second flexible material,
preparing a plurality of types of flexible materials as the second flexible material,
filling around the molded body with a flexible material for the resection area portion, and
filling other areas with a type of flexible material different from the flexible material for the resection area portion.

15. The method of producing a molded article according to claim 12, wherein
in the forming of the resection area portion, the resection area portion is formed so as to include a material stained with a predetermined staining material, and
in the forming of the molded body, the molded body formed so as to resemble the blood vessel through which the predetermined staining material is allowed to flow and to be hollow is formed so as to connect to the formed resection area portion.

16. The method of producing a molded article according to claim 12, wherein
the forming of the resection area portion is performed by
forming the covering portion in a state where the molded body is covered with the material for the resection area portion during the disposing of the molded body,
dissolving the outer portion, and
filling the second flexible material.

17. The method of producing a molded article according to claim 16, wherein
the material for the resection area portion includes a material stained by a predetermined staining material, and
in the forming of the molded body, the molded body formed so as to resemble the blood vessel through which the predetermined staining material is allowed to flow and to be hollow is formed so as to connect to the resection area portion formed based on the material for the resection area portion.

18. The method of producing a molded article according to claim 12, wherein
the resection area portion is formed for surgery simulation for removing a tumor.

19. A molded article, comprising:
a first molded portion including a first flexible material that is insoluble in a solvent, the first molded portion being formed as a covering portion having a predetermined shape by being formed so as to cover an outer portion including a material that is soluble in the solvent and having the predetermined shape; and
a second molded portion including a second flexible material, the second molded portion being formed as an internal area covered by the covering portion by filling an area covered by the first molded portion with the second flexible material, the area being obtained by dissolving the outer portion with the solvent, the outer portion being covered by the first molded portion.
